(19) United States
(12) Patent Application Publication
(10) Pub. No.: US 2008/0259751 A1
(43) Pub. Date: Oct. 23, 2008

(54) Recorder, Host Device, Drive Device, Recording Method, Instruction Method, Program, Integrated Circuit, Reproducing Device, Reproducing Method, and Write-Once-Read-Many Recording Medium

(75) Inventors: Tadashi Nakamura, Nara (JP); Yoshiho Gotoh, Osaka (JP)

Correspondence Address: SNELL & WILMER L.L.P. (Matsushita), 600 ANTON BOULEVARD, SUITE 1400, COSTA MESA, CA, 92626, US

(73) Assignee: MATSUSHITA ELECTRIC INDUSTRIAL CO., LTD., Osaka (JP)

(21) Appl. No.: 10/599,234

(22) PCT Filed: Mar. 22, 2005
(86) PCT No.: PCT/JP2005/005174

§ 371 Date: Jul. 8, 2008

(30) Foreign Application Priority Data
Mar. 23, 2004 (JP) 2004-085821
May 7, 2004 (JP) 2004-138920

(51) Int. Cl. G11B 20/10

(52) U.S. Cl. 369/47.13

(57) ABSTRACT

A recording apparatus for recording second information on a write-once recording medium having first information recorded thereon, the recording apparatus including: a host apparatus; and a drive apparatus, wherein the host apparatus includes a storage section for storing the second information; and an instruction section for instructing the drive apparatus to record the stored second information on the write-once recording medium, the drive apparatus includes a generation section for generating correlation information for correlating the first information and the second information; a head section for recording the second information on the write-once recording medium; and a control section for controlling the head section to record the second information and the correlation information on the write-once recording medium.

### TECHNICAL FIELD

The present invention relates to: a recording apparatus for recording second information on a write-once recording medium having first information recorded thereon; a host apparatus and a drive apparatus included in a recording apparatus; a recording method for recording second information on a write-once recording medium having first information recorded thereon; an instruction method; a program for executing a recording procedure; an integrated circuit; a reproduction apparatus for reproducing second information from a write-once recording medium having first information and second information recorded thereon; a host apparatus and a drive apparatus included in a reproduction apparatus; a reproduction method for reproducing second information from a write-once recording medium having first information and second information recorded thereon; and a program for executing a reproduction procedure; and a write-once recording medium.

### BACKGROUND ART

In recent years, various forms of information recording media have been used for recording digital data. Among others, write-once optical disks are gaining wide use although data can be recorded only once, since the cost thereof is inexpensive.

Examples of such optical disks include CD-R disks and DVD-R disks. Several methods for incrementally recording data on CD-R disks or DVD-R disks have been proposed (see, for example, Reference 1). The methods for incrementally recording data may be, for example, a VAT (Virtual Allocation Table) method, or a multiborder (multisession) method.

Operations for recording/reproducing digital data on/from DVD-R disks using the VAT method or multiborder method will be described.

Now, incrementally recording method using VAT will be described below with reference to the drawings. Herein, an operation of recording a file and directory tree structure shown in FIG. 11 on an information recording medium and a data structure which is formed as a result thereof when an example of the recording information medium is a DVD-R disk will be described in order.

First, a format process will be described with reference to FIG. 32. FIG. 32 shows data on a DVD-R disk immediately after the format process is performed wherein the DVD-R is an example of a conventional information recording medium 10100.

A DVD-R disk is an information recording medium defined by the DVD-R physical specification.

Further, files are recorded by using a volume file structure defined by the DVD-R file system specification. The DVD-R file system specification conforms to the ISO/IEC 13346 standard or the UDF (Universal Disk Format) specification. The description will be made below using the structure defined by the UDF specification.

As shown in FIG. 32, a data area of the information recording medium 10100 includes a lead-in area 10101 and a volume space 10109. The volume space 10109 includes a volume structure area 10410, a file structure/file area 10420 and a VAT (Virtual Allocation Table) structure area 10430.

In the volume structure area 10410, a volume structure defined by the UDF specification is to be recorded. In detail, the volume structure area 10410 includes an NSR descriptor, a primary volume descriptor, an implementation use volume descriptor, a partition descriptor, a logical volume descriptor, an unallocated space descriptor, a terminating descriptor, a logical volume integrity de-scriptor and an anchor volume descriptor pointer.

In the file structure/file area 10420, a file set descriptor 10421 and an FE (ROOT) 10422, which is a file entry of a ROOT directory file, are recorded. The FE (ROOT) 10422 is an origin of a directory tree in a partition space. The file entry (hereinafter, referred to as FE) has a data structure defined by the UDF specification for managing the position and the size of the files to be recorded in the volume space. Herein, in order to simplify the description, the ROOT directory file is assumed to be recorded in the FE (ROOT) 10422.

In the VAT structure area 10430, a VAT 10431 and a VAT ICB 10432 are recorded. The VAT is a data structure defined by the UDF specification for the purpose of simplifying a process of updating the file structure in the write-once recording medium.

When the VAT is used, a recording location of the file structure data such as FE in the volume space is specified using virtual address in a virtual address space. VAT holds a correspondence between a logical address, which is a recording location in a logical address space on the information recording medium, and the virtual address. With such a structure, data can be rewritten virtually even in an information recording medium which is not rewritable, such as a DVD-R disk. The recording location of the VAT on the information recording medium is specified by VAT ICB allocated to a last sector of an area on which data is recorded on the information recording medium. Further, the lead-in area 10101 includes a physical format information area 10104. In the physical format information area 10104, physical format information is recorded for recording management information of various areas allocated to the information recording medium 10100. The management information may be, for example, address information of a border-out area or the like. Immediately after the format process is performed, only an area of the physical format information area 10104 is secured, and data is not recorded yet in the area.

With reference to FIG. 33, a procedure for recording directory (Dir-A) and data file (File-a) of the file and directory structure shown in FIG. 11 will be described.

When a process of recording the directory (Dir-A) and data file (File-a) on the information recording medium 10100 shown in FIG. 32 is performed, a data file (File-a) 10501, a FE (File-a) 10502, a FE (Dir-A) 10503 and FE (ROOT) 10504 are recorded in the file structure/file area 10500 as shown in FIG. 33. In this example, the directory file is included in the FE (Dir-A) 10503.

In the VAT structure area 10520, a VAT 10521, to which the newly-recorded FE 10502, FE 10503 and FE 10504 are registered, and a VAT ICB 10522 are recorded.

When a closing process is performed, first, predetermined data is recorded in the border-out area 10530 except for a next border marker 10531. Further, predetermined data is recorded in the physical format information area 10104 in the lead-in area 10101 which has remained unrecorded after the format process.

The closing process is performed so as to allow the information reproduction apparatus to search for the latest volume file structure.

When the file recording process and the closing process are performed for the information recording medium 10100 having the data structure after the format process as shown in FIG. 32, the data structure as shown in FIG. 33 is formed in the information recording medium 10100.

With reference to FIG. 34, a recording procedure for a directory (Dir-B) and a data file (File-b) of the file and directory structure shown in FIG. 11 will be described.

Herein, the data file (File-b) 10601 and the file structure related thereto, i.e., a file (File-b) 10601, a FE (File-b) 10602, a FE (Dir-B) 10603 and a FE (ROOT) 10604 are recorded in the file structure/file area 10600.

In a VAT structure area 106100, the latest VAT structure, i.e., a VAT 106101 and a VAT ICB 10602 are recorded.

At last, by performing the closing process again, predetermined data is recorded in a border-out area 106200 except for a next border marker 106201. Further, the next border marker 10531 allocated in the border-out area 10530 and a border-in area 106300 including the physical format information area 106301 are recorded.

When such file recording process and closing process are performed for the information recording medium 10100 having the data structure shown in FIG. 33, the data structure as shown in FIG. 34 is formed on the information recording medium 10100.

As described above, each time the closing process is performed, an area interposed between the lead-in area 10101 or the border-in area of the volume space 10109 and the border-out area is formed. Hereinafter, such an area is called a bordered area. For example, in FIG. 34, there are bordered area #1 10700 and the bordered area #2 10701. The bordered area is a concept similar to a session in a CD-R disk.

Next, with reference to a flowchart for a re-production procedure shown in FIG. 35, a reproduction operation of a file will be described. Herein, an operation of reproducing the data file (File-a) 10501 will be described as an example.

First, data in the physical format information area 10104 in the lead-in area 10101 is reproduced, and the physical format information is obtained (step S11101).

Next, data of the next border marker is reproduced (step S11102).

The physical format information obtained in step S11101 (or step S11103) includes address information of the border-out area. Since the data of the next border marker is recorded at the predetermined position of the border-out area, the next border marker is reproduced from the position.

For example, in FIG. 34, the physical format information area 10104 includes address information of the border-out area 10530. Further, the physical format area 106301 included in the border-in area 106300 includes address information of the border-out area 106200.

When the next border marker included in physical format information obtained in step S11101 (or step S11103) has been already recorded, there is a newer bordered area. Thus, step S11103 and the following steps are performed.

In accordance with the address information of the border-in area included in the physical format information obtained in step S11101, information recorded in the next border-in area is reproduced (step S11103). The address information of the border-in area included in the physical format information can also be obtained in step S11104. From the reproduced border-in area, the physical format information is obtained.

On the other hand, when the next border marker reproduced in step S11102 remains unrecorded, the current bordered area is the latest one. Thus, step S11104 and the following steps are performed.

When it reaches the latest bordered area, with reference to the latest obtained physical format information, an end physical address of the area which is accessible is obtained (step S11104).

In FIG. 34, the end of the bordered area #2 10701 is the end of the accessible area.

Then, at last, file reproduction is performed as follows.

Information recorded in the volume structure area 10410 is reproduced first (step S11105). The reproduced information (volume structure) includes address information of file set descriptor 10421 and partition starting location. When the VAT method is employed, a virtual partition map defined by the UDF specification is included in the volume structure. Thus, based on the information, it is recognized that the VAT structure is recorded in the volume space.

The VAT ICB 106102 recorded at the end of the accessible area is reproduced (step S11106).

VAT recording location information is obtained from the read out VAT ICBP 106102, and the VAT 106101 is read out.

When a target file and/or management information thereof is managed using the virtual address, the VAT 106101 obtained in step S11106 is used for making reference to the VAT entry to which file entry of the target file and/or directory is registered (step S11107).

A conversion process from the virtual address to the logical address is performed. Then, with having the file set descriptor 10421 in the file structure/file area 10420 as an origin, the FE (ROOT) 10604 in the file structure/file area 10600, ROOT directory included in the FE (ROOT) 10604, the FE (Dir-A) 10503 in the file structure/file area 10500, directory (Dir-A) included in the FE (Dir-A) 10503 and the FE (File-a) 10502 are sequentially read out.

The recording location of the data file (File-a) 10501 is obtained from the FE (File-a) 10502, and the reproduction of the data file (File-a) 10501 is performed.

A method for incremental recording to the DVD-R disks using the VAT method has been described above. However, the multiborder method is also known as an in-cremental recording method different from the VAT method. A similar method when used in the CD-R disks is called a multisession method.

In the multiborder method, data is incrementally recorded with a bordered area as unit, and the volume structure and the file structure are recorded for each bordered area.

In the multiborder method, a system of updating data using the virtual address such as VAT is not used. When the file structure is updated, the volume structure and the file structure are newly generated and re-recorded in a new bordered area. Reproduction using the multiborder method determines the latest bordered area and reads out the latest volume structure therefrom.

Thereafter, a specific file can be reproduced in order by tracing data in accordance with the data structure defined by the UDF specification. For example, data can be read out with a reproduction procedure similar to that for read-only disks like DVD-ROM.

Further, when the multiborder/multisession method is used, efficient data recording using the image data is performed. When all the files which are desired for recording are known, for example, when taking a backup of data, the data for all files which is desired to be recorded in a hard disk drive and a file including all the volume structure and file structure thereof are created. The file is image data. For recording the image data, one bordered area (or a session) is allocated, and the image data is continuously recorded in the area. Since recording is performed continuously, and the file structure has been already created, overhead at the time recording becomes small. Thus, recording of the image data can be performed at a high speed.

FIG. 36 shows a computer system 10200 and a drive apparatus 10300 disclosed in Reference 2.

The computer system 10200 includes a computer memory 10210 and a temporary memory 10220, and transfer data to and from a write-once recording medium 10400. The temporary memory 10220 can transfer data to both the computer memory 10210 and the write-once recording medium 10400. The temporary memory 10220 includes a system file allocation area 10221, a medium directory area 10224 and a data file area 10225. The system file allocation area 10221 is an area for storing a file allocation table 10222 and an OS (operating system) directory 10225.

An operation of the computer system 10200 when recording a user file (user file including at least one of video data and audio data) on the write-once recording medium 10400 will be described.

FIG. 37 shows a data structure of the write-once recording medium 10400. In a file directory area 10510 of the write-once recording medium 10400, a directory entry corresponding to the user file recorded in a file data area 10610 is recorded. The directory entry is a file structure in the write-once recording medium 10400, and includes information of a recording location, a file size, a file name and the like of the user file.

An operation for recording a new user file on the write-once recording medium 10400 shown in FIG. 37 will be described. Herein, the new user file is a user file generated by updating the user file recorded in the file data area 10610. The computer system 10200 reads out all the directory entries from the write-once recording medium 10400 and stores in a medium directory area 10224. Then, the computer system 10200 perform a conversion of the in-formation of the directory entry recorded in the medium directory area 10224, and records the file allocation table 10222 and OS directory 10225 in the system file allocation area 10221. The file allocation table 10222 and the OS directory 10225 have the same structure as the file structure of a rewritable recording medium.

Next, the computer system 10200 transfers the new user file from the computer memory 10210 to the write-once recording medium 10400 via the data file area 10225. The new user file is recorded in, for example, a file data area 10620 shown in FIG. 38. In accordance with recording of the new user file, information in the system file allocation area 10221, i.e., the file allocation table 10222 and the OS directory 10225 are updated. In accordance with the updating of the file allocation table 10222 and the OS directory 10225, the directory entry stored in the medium directory area 10224 is updated.

Last, the updated directory entry is recorded on the write-once recording medium 10400. In FIG. 38, the updated directory entry is recorded in the file directory area 10510b.

As described above, in the recording operation described above, the directory entry (file structure) on the write-once recording medium 10400 is read out to the temporary memory 10220, and the directory entry is converted to a file structure same as that of a rewritable recording medium. In accordance with the recording of the new user file, the file structure on the temporary memory 10220 is updated. The file structure of the rewritable recording medium is again reconverted into the file structure on the write-once recording medium 10400 and then is recorded on the write-once recording medium 10400.

In the reconversion process, all the directory entries are relocated from the file directory area 10510 to the file directory area 10510b. For example, in FIG. 38, the directory entry 10511 is relocated in the directory entry 10511b.

As shown in FIG. 38, the directory entry 10511 and the directory entry 10511b respectively have values such as “0” to “c” and “d” to “g” as logical address values. Modification to the logical address values is directly reflected in the information included in the directory entry in the course of the conversion process performed in the temporary memory 10220. For example, the logical address for making reference to the directory entry 10512 is “b”. When the new user file is recorded, the logical value for making reference to the directory entry 10512b corresponding to the directory entry 10512 is “f”. Similarly, all the information related to the logical addresses in the file directory area is modified.

For incrementally recording data in the write-once recording medium 10400, methods of reading out and converting the file structure such as directory information and/or location information recorded on the medium are widely used. This is because data cannot be recorded in the recorded area in the write-once recording medium. Further, since the conversion process of the file structure is required, the conversion process specific to the write-once medium needs to be performed when data is reproduced and recorded.

Reference 1: U.S. Pat. No. 5,666,531

Reference 2: Japanese Patent No. 3005645

### DISCLOSURE OF THE INVENTION

However, in the method as described-above, the reproduction operation of the directory or the file specific to the write-once recording medium is required. Thus, there is a problem in that a system which can only perform a reproduction operation of a read-only recording medium or rewritable recording medium cannot reproduce data in the write-once recording medium.

For example, for reproducing a user file recorded on a write-once recording medium such as DVD-R disk by the recording method shown in Reference 2, the recording location of the latest file structure (for example, the file directory area 10521b in FIG. 38) should be recognized. In the recording method shown in Reference 2, the position of the file directory area 10510b cannot be determined uniquely. Thus, some kind of method is required for recognizing the position. As such a method, for example, the multiborder/multisession method has to be used.

Specifically, a first bordered area is set, and a file directory area 10510 and a file data area 10610 are provided in the first bordered area. Further, a second bordered area is set, and a file directory area 10510b and a file data area 10620 are provided in the second bordered area. The file directory area is provided at a predetermined position in each of the bordered areas (for example, at headers of the areas). When the reproduction operation is performed, the position of the latest bordered area is obtained by reading out the physical format information in the lead-in area or the border-in area in order. Accordingly, even when the recording method shown in Reference 2 is used, it is possible to recognize the position of the latest file directory area if the multiborder/multisession method is used. However, this example still does not solve the problem that the system which does not support the multiborder (for example, read-only system) cannot read out the information.

In view of the above-described problem, the object of the present invention is to provide: a write-once information recording medium which is compatible with a system which can only perform a reproduction operation for a read-only recording medium or a rewritable recording medium; a recording apparatus, a host apparatus, and a recording method for recording information on the write-once information recording medium; a reproducing apparatus, a host apparatus and a reproducing method for reproducing the information recorded on the write-once information recording medium; and a program for instructing the apparatuses to execute a recording operation and a reproduction operation.

A recording apparatus according to the present invention is a recording apparatus for recording second information on a write-once recording medium having first information recorded thereon, the recording apparatus including: a host apparatus; and a drive apparatus, wherein the host apparatus includes a storage section for storing the second information; and an instruction section for instructing the drive apparatus to record the stored second information on the write-once recording medium, the drive apparatus includes a generation section for generating correlation information for correlating the first in-formation and the second information; a head section for recording the second information on the write-once re-cording medium; and a control section for controlling the head section to record the second information and the correlation information on the write-once recording medium, thereby the objective described above being achieved.

The first information may include file management information, the second information may include update information generated by updating the file management information, the generation section may generate first correlation information for correlating the file management information and the update information and the control section may control the head section to record the update information and the first correlation information on the write-once recording medium.

The write-once recording medium may include at least one first track and at least one second track which may be different from the at least one first track, the at least one first track may be an area for recording the file management information and the at least one second track may be an area for recording user data.

The host apparatus may further include an obtaining section for obtaining last location information indicating a last location of information recorded on the write-once recording medium; and a determination section for determining a recording location of data based on the last location information, and the control section may control the head section such that the head section records the data at the recording location.

The first information may further includes management information, the management information managing the file management information, the second information may include first update information generated by updating the management information, the generation section may generate second correlation information for correlating the management information and the first update information and the control section may control the head section to record the first update information and the second correlation information on the write-once recording medium.

The write-once recording medium may include at least one first track and at least one second track which may be different from the at least one first track, the at least one first track may be an area for recording the file management information and the at least one second track may be an area for recording user data.

The host apparatus may further include an obtaining section for obtaining last location information indicating a last location of information recorded on the write-once recording medium; and a determination section for determining a recording location of data based on the last location information, and the control section may control the head section such that the head section records the data at the recording location.

A host apparatus according to the present invention is a host apparatus included in a recording apparatus for recording second information on a write-once recording medium having first information recorded thereon, the recording apparatus further including a drive apparatus for recording correlation information for correlating the first information and the second information and the second information on the write-once recording medium, the host apparatus including: a storage section for storing the second information; and an instruction section for instructing the drive apparatus to record the stored second information on the write-once recording medium, thereby the objective described above being achieved.

The first information may include file management information and the second information may include update information generated by updating the file management information.

The write-once recording medium may include at least one first track and at least one second track which may be different from the at least one first track, the at least one first track may be an area for recording the file management information and the at least one second track may be an area for recording user data.

The host apparatus may further include: an obtaining section for obtaining last location information indicating a last location of information recorded on the write-once recording medium; and a determination section for determining a recording location of data based on the last location information, and the drive apparatus may record the data at the recording location.

The first information may further include management information, the management information managing the file management information, and the second information may include first update information generated by updating the management information.

A drive apparatus according to the present invention is a drive apparatus included in a recording apparatus for recording second information on a write-once recording medium having first information recorded thereon, the recording apparatus further including a host apparatus for instructing the drive apparatus to record the second information on the write-once recording medium, the drive apparatus including: a generation section for generating correlation information for correlating the first information and the second information; a head section for recording the second information on the write-once recording medium; and a control section for controlling the head section to record the second information and the correlation information on the write-once recording medium, thereby the objective described above being achieved.

The first information may include file management information, the second information may include update information generated by updating the file management information, the generation section may generate first correlation information for correlating the file management information and the update information and the control section may control the head section to record the update information and the first correlation information on the write-once recording medium.

The write-once recording medium may include at least one first track and at least one second track which may be different from the at least one first track, the at least one first track may be an area for recording the file management information and the at least one second track may be an area for recording user data.

The host apparatus may determine a recording location of data based on last location information indicating a last location of information recorded on the write-once recording medium, and the control section may control the head section such that the head section records the data at the recording location.

The first information may further include management information, the management information managing the file management information, the second information may include first update information generated by updating the management information, the generation section may generate second correlation information for correlating the management information and the first update information, the control section may control the head section to record the first update information and the second correlation in-formation on the write-once recording medium.

A recording method according to the present invention is a recording method for recording second information on a write-once recording medium having first information recorded thereon, the recording method including: an instruction step of instructing to record the second information on the write-once recording medium; a generation step of generating correlation information for correlating the first information and the second information; and a recording step of recording the second information and the correlation information on the write-once recording medium, thereby the objective described above being achieved.

An instruction method according to the present invention is an instruction method executed by a host apparatus included in a recording apparatus for recording second information on a write-once recording medium having first information recorded thereon, the recording apparatus recording correlation information for correlating the first information and the second information and the second information on the write-once recording medium, the instruction method including: an instruction step of instructing to record the second information on the write-once recording medium, thereby the objective described above being achieved.

A method according to the present invention is a method executed by a drive apparatus included in a recording apparatus for recording second information on a write-once recording medium having first information recorded thereon, the recording apparatus instructing the drive apparatus to record the second information on the write-once recording medium, the method including: a generation step of generating correlation information for correlating the first information and the second information; and a recording step of recording the second information and the correlation information on the write-once recording medium, thereby the objective described above being achieved.

A program according to the present invention is a program for executing a recording procedure by a recording apparatus for recording second information on a write-once recording medium having first information recorded thereon, the recording procedure including an instruction step of instructing to record the second information on the write-once recording medium; a generation step of generating correlation information for correlating the first information and the second information; and a recording step of recording the second information and the correlation information on the write-once recording medium, thereby the objective described above being achieved.

A program according to the present invention is a program for executing an instruction procedure by a host apparatus included in a recording apparatus for recording second information on a write-once recording medium having first information recorded thereon, the recording apparatus recording correlation information for correlating the first information and the second information and the second information on the write-once recording medium, the instruction procedure including an instruction step of instructing to record the second information on the write-once recording medium, thereby the objective described above being achieved.

A program according to the present invention is a program for executing a recording procedure by a drive apparatus included in a recording apparatus for recording second information on a write-once recording medium having first information recorded thereon, the recording apparatus instructing the drive apparatus to record the second information on the write-once recording medium, the re-cording procedure including a generation step of generating correlation information for correlating the first information and the second information; and a recording step of recording the second information and the correlation information on the write-once recording medium, thereby the objective described above being achieved.

An integrated circuit according to the present invention is an integrated circuit included in a recording apparatus for recording second information on a write-once recording medium having first information recorded thereon, wherein the recording apparatus further include a drive apparatus for recording correlation information for correlating the first information and the second information and the second information on the write-once recording medium and the integrated circuit instructs the drive apparatus to record the second information on the write-once recording medium, thereby the objective described above being achieved.

An integrated circuit according to the present invention is an integrated circuit included in a recording apparatus for recording second information on a write-once recording medium having first information recorded thereon, the recording apparatus further including an apparatus for instructing the drive apparatus to record the second information on the write-once recording medium, the integrated circuit including: a generation section for generating correlation information for correlating the first information and the second information; and a control section for recording the second information and the correlation information on the write-once recording medium, thereby the objective described above being achieved.

A reproduction apparatus according to the present invention is a reproduction apparatus for reproducing second information from a write-once recording medium having first information and the second information recorded thereon, correlation information for correlating the first information and the second information being further recorded on the write-once recording medium, the reproduction apparatus including: a host apparatus; and a drive apparatus, wherein the host apparatus may include an instruction section for instructing the drive apparatus to reproduce the second information from the write-once recording medium, the drive apparatus may include a head section for reproducing the second information from the write-once recording medium; and a control section for controlling the head section to reproduce the second information from the write-once recording information based on the correlation information, thereby the objective described above being achieved. The first information may include file management information, the second information may include update information generated by updating the file management information, first correlation information for correlating the file management information and the update information may be recorded on the write-once recording medium and the control section controls the head section to reproduce the update information from the write-once recording medium based on the first correlation information.

The write-once recording medium may include at least one first track and at least one second track which may be different from the at least one first track, the at least one first track may be an area for recording the file management information and the at least one second track may be an area for recording user data.

The first information may further include management information, the management information managing the file management information, the second information may include first update information generated by updating the management information, second correlation information for correlating the management information and the first update information may be recorded on the write-once recording medium and the control section may control the head section to reproduce the first update information from the write-once recording medium based on the second correlation information.

A host apparatus according to the present invention is an a host apparatus included in a reproduction apparatus for reproducing second information from a write-once recording medium having first information and the second information recorded thereon, correlation information for correlating the first information and the second information being further recorded on the write-once recording medium, the reproduction apparatus further including a drive apparatus for reproducing the second information from the write-once recording medium based on the correlation information, the host apparatus including: an instruction section for instructing the drive apparatus to reproduce the second information from the write-once recording medium, thereby the objective described above being achieved.

The first information may include file management information and the second information may include update information generated by updating the file management information.

The write-once recording medium may include at least one first track and at least one second track which may be different from the at least one first track, the at least one first track may be an area for recording the file management information and the at least one second track may be an area for recording user data.

The first information may further include management information, the management information managing the file management information and the second information may include first update information generated by updating the management information.

A drive apparatus according to the present invention is a drive apparatus included in a reproduction apparatus for reproducing second information from a write-once recording medium having first information and the second information recorded thereon, correlation information for correlating the first information and the second information being further recorded on the write-once recording medium, the reproduction apparatus further including a host apparatus for instructing the drive apparatus to reproduce the second information from the write-once recording medium, the drive apparatus including: a head section for reproducing the second information from the write-once recording medium; and a control section for controlling the head section to reproduce the second information from the write-once recording information based on the correlation information, thereby the objective described above being achieved.

The first information may include file management information, the second information may include update information generated by updating the file management information, first correlation information for correlating the file management information and the update information may be recorded on the write-once recording medium and the control section may control the head section to reproduce the update information from the write-once recording medium based on the first correlation information.

The write-once recording medium may include at least one first track and at least one second track which may be different from the at least one first track, the at least one first track may be an area for recording the file management information and the at least one second track may be an area for recording user data.

The first information may further include management information, the management information managing the file management information, the second information may include first update information generated by updating the management information, second correlation information for correlating the management information and the first update information may be recorded on the write-once recording medium and the control section may control the head section to reproduce the first update information from the write-once recording medium based on the second correlation information.

A reproduction method according to the present invention is a reproduction method for reproducing second information from a write-once recording medium having first information and the second information recorded thereon, correlation information for correlating the first information and the second information being further recorded on the write-once recording medium, the reproduction method including: an instruction step of instructing to reproduce the second information from the write-once recording medium; and a reproduction step of reproducing the second information from the write-once recording medium based on the correlation information, thereby the objective de-scribed above being achieved.

An instruction method according to the present invention is an instruction method executed by a host apparatus included in a reproduction apparatus for reproducing second information from a write-once recording medium having first information and the second information recorded thereon, correlation information for correlating the first information and the second information being further recorded on the write-once recording medium, the reproduction apparatus reproducing the second information from the write-once recording medium based on the correlation information, the instruction method including: an instruction step of instructing the drive apparatus to reproduce the second information from the write-once recording medium, thereby the objective described above being achieved.

An method according to the present invention is a method executed by a drive apparatus included in a reproduction apparatus for reproducing second information from a write-once recording medium having first information and the second information recorded thereon, correlation information for correlating the first information and the second information being further recorded on the write-once recording medium, the reproduction apparatus instructing the drive apparatus to reproduce the second information from the write-once recording medium, the method including: a step of reproducing the second information from the write-once recording medium based on the correlation information, thereby the objective described above being achieved.

A program according to the present invention is a program for executing a reproduction procedure by a reproduction apparatus for reproducing second information from a write-once recording medium having first information and the second information recorded thereon, correlation information for correlating the first information and the second information being further recorded on the write-once recording medium, the reproduction procedure including an instruction step of instructing to reproduce the second information from the write-once recording medium; and a reproduction step for reproducing the second information from the write-once recording medium based on the correlation information, thereby the objective described above being achieved.

A program according to the present invention is a program for executing an instruction procedure by a host apparatus included in a reproduction apparatus for reproducing second information from a write-once recording medium having first information and the second information recorded thereon, correlation information for correlating the first information and the second information being further recorded on the write-once recording medium, the reproduction apparatus reproducing the second information from the write-once recording medium based on the correlation information, the instruction procedure including an instruction step of instructing to record the second information on the write-once recording medium, thereby the objective described above being achieved.

A program according to the present invention is a program for executing a reproduction procedure by a drive apparatus included in a reproduction apparatus for reproducing second information from a write-once recording medium having first information and the second information recorded thereon, correlation information for correlating the first information and the second information being further recorded on the write-once recording medium, the reproduction apparatus instructing the drive apparatus to reproduce the second information from the write-once recording medium, the reproduction procedure including a step of reproducing the second information from the write-once recording medium based on the correlation information, thereby the objective described above being achieved.

An integrated circuit according to the present invention is an integrated circuit included in a reproduction apparatus for reproducing second information from a write-once recording medium having first information and the second information recorded thereon, wherein correlation information for correlating the first information and the second information is further recorded on the write-once recording medium, the reproduction apparatus further including a drive apparatus for reproducing the second information from the write-once recording medium based on the correlation information and the integrated circuit instructs the drive apparatus to reproduce the second information from the write-once recording medium, thereby the objective described above being achieved.

An integrated circuit according to the present invention is an integrated circuit included in a reproduction apparatus for reproducing second information from a write-once recording medium having first information and the second information recorded thereon, correlation information for correlating the first information and the second information being further recorded on the write-once recording medium, the reproduction apparatus further including an apparatus for instructing the integrated circuit to reproduce the second information from the write-once recording medium, the integrated circuit including: a control section for reproducing the second information from the write-once recording medium based on the correlation information, thereby the objective described above being achieved.

A write-once recording medium according to the present invention is a write-once recording medium for recording first information, second information and correlation information for correlating the first information and the second information, thereby the objective described above being achieved.

The present invention includes a host apparatus and a drive apparatus. The present invention can generate correlation information for correlating first information and second information by the drive apparatus and record the second information and the correlation information on a write-once recording medium. Therefore, it is possible to record the correlation information on the write-once recording medium without having the correlation information being generated by the host apparatus. As a result, on the logical space, this file structure is the same as the read-only and rewritable file structure. Thus, it is not necessary to use a file system specific to the write-once recording medium, as performed in the multiborder system.

Further, it is possible to limit information to be updated, by using update information, to some of file management information, not the entire file management information. Thus, it is possible to increase the speed of updating a file.

Furthermore, it is possible separate an area for recording the file management information and an area for recording user data. Therefore, the file management information and the user data are not recorded in the same area. As a result, it is possible to increase the speed of reading the file management information.

Still further, it is possible to perform a management with a last recorded location (one sector address) of a track without managing an empty area, by space bit map, for each sector.

Still further, it is possible to limit the information to be updated to some (information which manages the file management information) of the file management information, and not to the entire file management information. Thus, it is possible to further increase the speed of updating the file.

Still further, by updating the file management information, it is possible to expand an empty area. Thus, even when there are no empty areas left, it is possible to allocate an area for recording data by expanding an empty area.

The present invention includes a host apparatus and a drive apparatus. The present invention can reproduce second information from a write-once recording medium based on correlation information for correlating first information and the second information by the drive apparatus. Therefore, it is possible to reproduce the second information by the drive apparatus from the write-once recording medium without reproducing the second information by the host apparatus. As a result, there is no need for recording a new file system in a memory of the host apparatus.

Further, it is possible to limit the information to be updated to some (file management information) of the file, and not to the entire file. Thus, it is possible to increase the speed of updating the file.

Furthermore, it is possible separate an area for recording the file management information and an area for recording user data. Therefore, the file management information and the user data are not recorded in the same area. As a result, it is possible to increase the speed of reading out the file management information.

Still further, it is possible to limit the information to be updated to some (information which manages file management information) of the file, and not to the entire file. Thus, it is possible to further increase the speed of updating the file.

According to the present invention, even when efficient file incremental recording using image data is performed, information in a predetermined area can be rewritten by a replacement mechanism. Thus, this file structure is the same as the read-only file structure, and reproduction compatibility can be realized.

According to the present invention, correlation information for correlating first information and second information is recorded on a recording medium. By performing a reproduction based on the correlation information, the second information which is information updated from the recording medium can be correctly reproduced even when the reproduction system is a system which can only perform a reproduction operation for a read-only recording medium or a rewritable recording medium.

According to the present invention, even when sequential recording for file is performed, it is possible to efficiently perform an incremental recording, and a high-speed access to the data file can be realized.

### BRIEF DESCRIPTION OF THE DRAWINGS

FIG. 1A is a view showing an appearance of a write-once recording medium 100 according to Embodiment 1 of the present invention.

FIG. 1B is a view showing an example of a data structure of data recorded on the write-once recording medium 100 according to Embodiment 1 of the present invention.

FIG. 2 is a view showing an example of a data structure of the write-once recording medium 100.

FIG. 3 is a view showing another example of a data structure of the write-once recording medium 100.

FIG. 4A is a view showing a data structure of a replacement management information list 1000.

FIG. 4B is a view showing a data structure of replacement management information 1010, which is one of a plurality of replacement management information.

FIG. 5 is a view showing an information recording/reproduction apparatus 300A according to Embodiment 1 of the present invention.

FIG. 6 is a view showing a recording procedure according to Embodiment 1 of the present invention.

FIG. 7 is a view showing a reproduction procedure according to Embodiment 1 of the present invention.

FIG. 8A is a view for describing empty area management by the sequential recording method.

FIG. 8B is a view for describing the empty area management by the random recording method.

FIG. 9A is a view showing a data structure of session management information 200.

FIG. 9B is a view showing a data structure of one of a plurality of track management information 210.

FIG. 9C is a view showing a data structure of space bitmap management information 220.

FIG. 10 is a view showing a data structure of disk structure information 1100.

FIG. 11 is a view showing an example of a file and directory tree structure recorded on the write-once recording medium 100.

FIG. 12 is a view showing another example of a data structure of the write-once recording medium 100.

FIG. 13 is a view showing an example of a data structure of first image data 500.

FIG. 14 is a view showing another example of a data structure of first metadata file 440.

FIG. 15 is a view showing the reference relationship between data included in a volume structure and a file structure, respectively.

FIG. 16A is a view showing an example of a data structure of a main volume structure area 410.

FIG. 16B is a view showing an example of a data structure of a reserve volume structure area 411.

FIG. 17 is a view showing an example of a file and directory tree structure recorded on the write-once recording medium 100.

FIG. 18 is a view showing another example of a data structure of the write-once recording medium 100.

FIG. 19 is a view showing an example of a data structure of second image data 650.

FIG. 20 is a view showing an information recording/reproduction apparatus 300B according to Embodiment 2 of the present invention.

FIG. 21 is a view showing a recording procedure according to Embodiment 2 of the present invention.

FIG. 22 is a view showing a reproduction procedure according to Embodiment 2 of the present invention.

FIG. 23 is a view showing an example of a data structure of the write-once recording medium 100 according to Embodiment of the present invention.

FIG. 24 is a view showing an example of a data structure of the write-once recording medium 100 according to Embodiment of the present invention.

FIG. 25 is a flowchart showing a recording procedure according to Embodiment 3 of the present invention.

FIG. 26 is a flowchart showing a procedure process according to Embodiment 3 of the present invention.

FIG. 27 is a view showing a data structure of the write-once recording medium 100 according to Embodiment 4 of the present invention.

FIG. 28 is a view showing a data structure of the write-once recording medium 100 where a file and directory structure is recorded by using the VAT method.

FIG. 29 is a view showing an example of a file and directory structure recorded on the write-once recording medium 100.

FIG. 30 is a view showing the write-once recording medium 100 created by changing a data structure by a conversion process according to Embodiment 5 of the present invention.

FIG. 31 is a view showing a data structure of a write-once recording medium 100b which has two layers of recording surfaces.

FIG. 32 is a view showing data on a DVD-R disk immediately after the format process is performed wherein the DVD-R is an example of a conventional information recording medium 10100.

FIG. 33 is a view for describing a procedure of recording a directory (Dir-A) and a data file (File-a) of a file and directory structure.

FIG. 34 is a view for describing a recording procedure for a directory (Dir-A) and a data file (File-a) of a file and directory structure.

FIG. 35 is a flowchart for describing for a file reproduction operation.

FIG. 36 is a view showing a computer system 10200 and a drive apparatus 10300 disclosed in Reference 2.

FIG. 37 is a view showing a data structure of a write-once recording medium 10400.

FIG. 38 is a view showing a data structure on a recording medium after a recording process by a conventional recording method.

100 write-once recording medium
101 lead-in area
102 data area
103 lead-out area
104 first disk management information
105 second disk management information
106 inner spare area
107 outer spare area
108 user area
300B recording/reproduction apparatus
301 system control section
302 first memory circuit
303 I/O bus
304 magnetic disk apparatus
305 host apparatus
310 drive apparatus
311 drive control section
312 second memory circuit
313 internal bus
314 recording/reproduction section
401 first image data
403 first file structure
405 first user file
407 first address information

### BEST MODE FOR CARRYING OUT THE INVENTION

Hereinafter, embodiments of the present invention will be described with reference to the accompanying drawings.

### 1. Embodiment 1

1-1. Write-Once Recording Medium

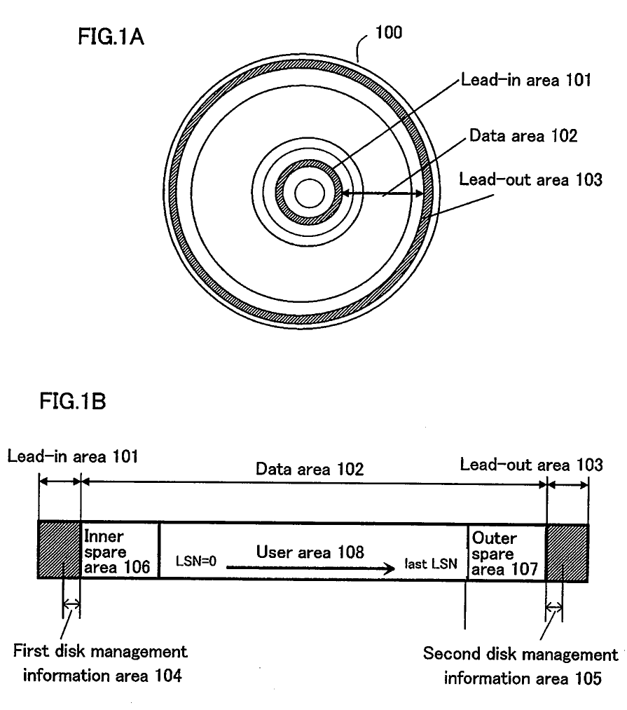

FIG. 1 shows a write-once recording medium 100 according to Embodiment 1 of the present invention.

FIG. 1A shows an appearance of the write-once recording medium 100 according to Embodiment 1 of the present invention. In the write-once recording medium 100, a lead-in area 101 is allocated in the inner-most periphery of the write-once recording medium 100, a data area 102 is allocated next the lead-in area 101, and a lead-out area 103 is allocated in the outer-most periphery of the write-once recording medium 100. The lead-in area 101, the data area 102 and the lead-out area 103 are concentric.

In the lead-in area 101, for example, reference information necessary for an optical pickup to access the write-once recording medium 100, information for identifying between the write-once recording medium 100 and other write-once recording media are recorded. In the lead-out area 103, information similar to that in the lead-in area 101 is recorded.

The data area 102 is separated into sectors, i.e., the smallest units for access. Data is recorded or reproduced with ECC blocks (or, ECC clusters) including a plurality of sectors as the smallest units. FIG. 1B shows an example of a data structure of data recorded on the write-once recording medium 100 according to Embodiment 1 of the present invention. In FIG. 1B, the lead-in area 101, the data area 102 and the lead-out area 103 are shown in the lateral direction of the figure.

The lead-in area 101 includes a first disk management information area 104. The lead-out area 103 includes a second disk management information area 105. Disk management information (e.g., replacement information, session management information, track management information and space bitmap management information) is recorded in each of the first management information area 104 and the second disk management information area 105.

The data area 102 includes an inner spare area 106, an outer spare area 107 and a user area 108. If there is a defective area in the user area 108, at least portions of the inner spare area 106 and the outer spare area 107 are used to replace the defective area. For example, if there is the defective sector in the user area 108, at least portions of the inner spare area 106 and the outer spare area 107 are used as a replacement sector. In the at least some portions of the inner spare area 106 and the outer spare area 107, information related to the information recorded in the user area 108 is recorded.

In at least one of the inner spare area 106 and the outer spare area 107, an additional disk management information area may be provided. In the additional disk management information area, disk management information is recorded.

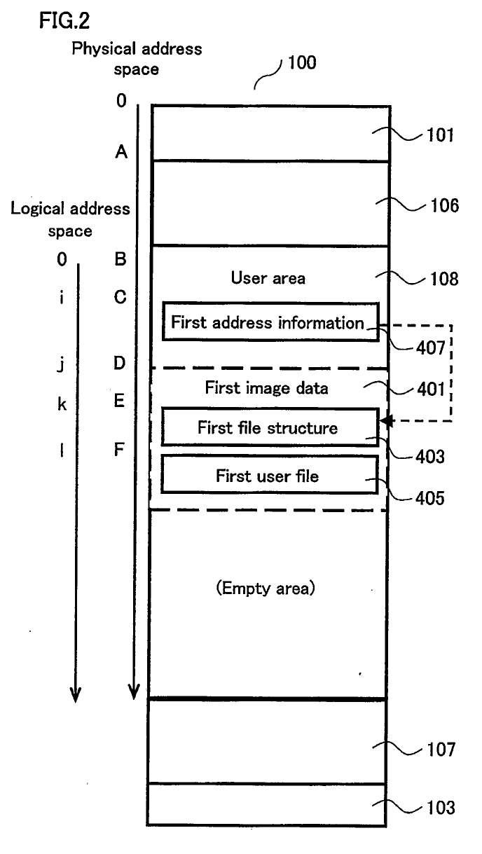

FIG. 2 shows an example of a data structure of the write-once recording medium 100. In FIG. 2, the same reference numbers are denoted to the areas which have been described with reference to FIG. 1, and the description thereof will be omitted.

In the user area 108, first image data 401 is recorded. The first image data 401 includes a first user file 405 and a first file structure 403 which corresponds to the first user file 405. The first file structure 403 includes, for example, a recording location, a file size and a file name of the first user file 405. The first user file 405 includes, for example, at least one of video data and audio data.

Physical addresses and logical addresses are allocated to the write-once recording medium 100. The physical addresses are indicated, for example, by location “0”, location “A”, location “K”, location “B”, location “C”, location “D”, location “E” and location “F”. The logical addresses are indicated, for example, by location “0”, location “i”, location “j”, location “k” and location “l”. First address information 407 is recorded in the logical address “i”. The first address information 407 includes location information indicating a recording location of the first file structure 403. The first file structure 403 is recorded, for example, in metadata partition (FID, FE and the like) of the UDF specification. By making reference to the first file structure 403, arrangement of information and reference to the information are performed based on the address information in the logical address space.

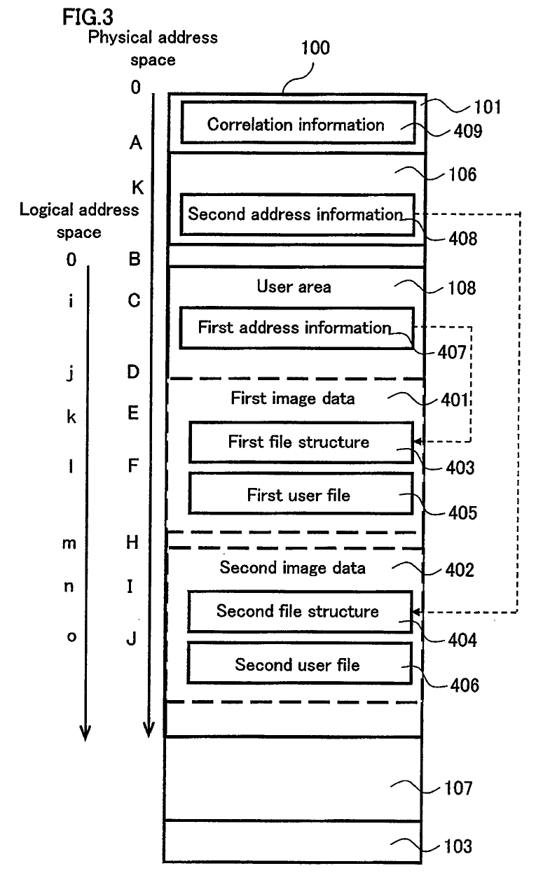

FIG. 3 shows another example of a data structure of the write-once recording medium 100. In FIG. 3, the same reference numbers are denoted to the areas which have been described with reference to FIGS. 1 and 2, and the description thereof will be omitted.

Physical addresses and logical addresses are allocated to the write-once recording medium 100. The physical addresses are indicated, for example, as described above, by location “0”, location “A”, location “K”, location “B”, location “C”, location “D”, location “E” and location “F” and further indicated by location “H”, location “I” and location “J”. The logical addresses are indicated, for example, as described above, by location “0”, location “i”, location “j”, location “k” and location “l” and further indicated by location “m”, location “n” and location “o”.

In the user area 108, second image data 402 is recorded. The second image data 402 includes a second user file 406 and a second file structure 404 which corresponds to the second user file 406. The second image data 402 is generated by updating the first image data 401 (e.g., adding or updating a user file for the first image data 401, or updating the file structure).

The second user file 406 is generated, for example, by an editing work by a user. The second file structure 404 is generated by updating the first file structure 403 along with the recording of the second user file 406.

Second address information 408 is recorded in the inner space area 106. The second address information 408 includes location information indicating a recording location of the second file structure 404. The second address information 408 is generated by updating the first address information 407.

Correlation information 409 for correlating the first address information 407 and the second address information 408 is recorded in the lead-in area 101. For example, the correlation information 409 indicates that physical address “C” corresponding to logical address “i” allocated at a location where the first address information 407 is recorded and physical address “K” allocated at a location where the second address information 408 is recorded are correlated to each other.

Alternatively, logical address “i” and physical address “K” can be correlated by the correlation information 409. Even when logical address “i” of the first address information 407 and physical address “K” of the second address information 408 are correlated to each other, the first address information 407 and the second address information 408 can be correlated by the correlation information 409.

1-2. Pseudo-Overwrite Recording

The present invention performs pseudo-overwrite recording on the write-once information recording medium 100 by using the replacement mechanism made up by the combination of replacement information and spare area (inner spare area 106, outer spare area 107). The pseudo-overwrite recording maps a physical address where data is practically recorded to another place without changing an apparent logical address of the area where the data is recorded.

In the pseudo-overwrite recording, for example, when it is instructed to overwrite data on the recorded logical address, new data is recorded at a physical address different from the physical address where the data has been recorded before the overwriting, and the replacement information is updated so as to maintain the original logical address. As a result, it is possible to realize a state that the data is apparently overwritten.

Replacement recording based on the replacement information and the spare area is performed together with a verification process. In the verification process, the data is recorded and then immediately thereafter, the data is reproduced, and the data to be recorded and the recorded data are compared with each other to check whether the data is correctly recorded.

When there is an error in the verification process, i.e., when the data is not correctly recorded, replacement recording is performed. In the replacement recording, the data is re-recorded in the spare area. This method is also referred to as a linear replacement.

It is possible to reduce recording time by not performing the verification process when the image data is recorded. On the other hand, in the pseudo-overwrite recording, when the data is recorded in the spare area, the reliability of data recording can be improved by performing the verification process.

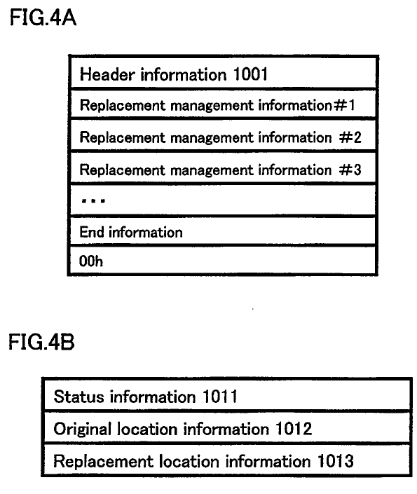

FIG. 4 shows an example of a structure of the replacement information. The replacement information is indicated, for example, by a replacement management information list.

FIG. 4A shows a data structure of a replacement management information list 1000. The replacement management information list 1000 is used for mapping in the pseudo-overwrite recording. The replacement management information list 1000 includes header information 1001 and a plurality of replacement management information. The header information 1001 indicates, for example the number of the plurality of replacement management information. Each of the plurality of replacement management information indicates one of the plurality of mappings.

FIG. 4B shows a data structure of replacement management information 1010, which is one of the plurality of replacement management information. The replacement management information 1010 includes status information 1011, original location information 1012 and replacement location information 1013.

The status information 1011 indicates a status regarding the mapping. The status information 1011 indicates, for example, whether the replacement location information 1013 is in a valid status or in an invalid status.

The mapping is performed by making reference to the original location information 1012 indicating the location before replacement (defective sector (or defective ECC block) and the replacement location information 1013 indicating the information after replacement. In the pseudo-overwrite recording, for example, by adding new replacement management information 1011 to the replacement management information list 1000, mapping of new data to the original logical address is performed.

1-3. Information Recording/Reproduction Apparatus

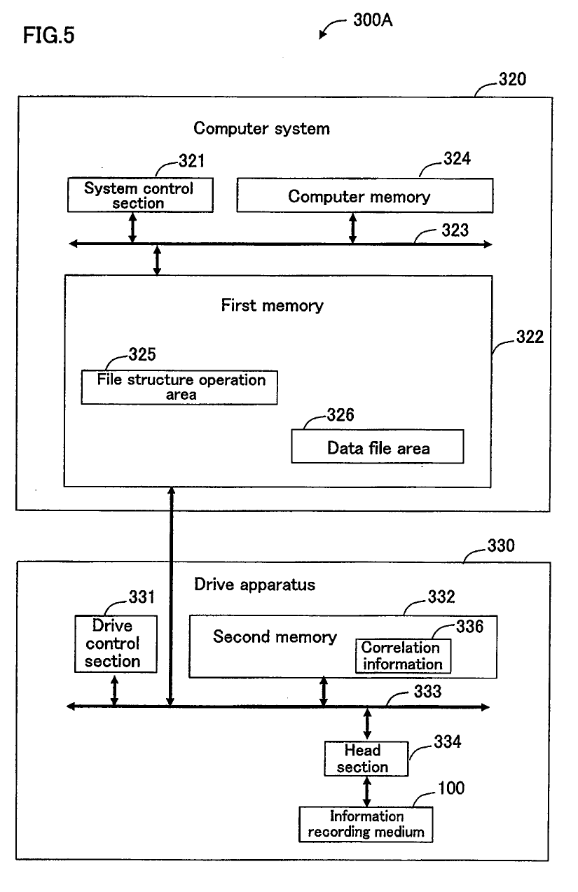

FIG. 5 shows an information recording/reproduction apparatus 300A according to Embodiment 1 of the present invention. The recording/reproduction apparatus 300A realizes a pseudo-overwrite recording. The information recording/reproduction apparatus 300A includes a computer system 320 and a drive apparatus 330. The computer system 320 functions as a host apparatus (e.g., personal computer). The information recording/reproduction apparatus 300A functions as one of a recording apparatus, a reproduction apparatus and a recording/reproduction apparatus.

The computer system 320 includes a system control section 321, a first memory 322, a computer memory 324 and an I/O bus 323. The first memory 322 is, for example a temporary memory. Data is transferred between the computer system 320 and the write-once recording medium 100 via the drive apparatus 330.

The system control section 321 controls the first memory 322 and the computer memory 324. For example, the system control section 321 controls the first memory 322 such that the first memory 322 transfers data to both the computer memory 324 and the drive apparatus 330. The first memory 322 includes a file structure operation area 325 and a data file area 326. Furthermore, the system control section 321 instructs the drive apparatus 330 to record the information stored in the first memory 322 on the write-once recording medium.

The drive apparatus 330 is structured so as to mount the write-once recording medium thereon. The drive apparatus 330 includes a drive control section 331, a second memory 332, an internal bus 333 and a head section 334 for recording information on the write-once recording medium 100. The second memory 332 is, for example, a temporary memory. The drive apparatus 330 transfers data to and from the write-once recording medium 100.

The drive control section 331 controls the second memory 332 and the head section 334. For example, the drive control section 331 controls the second memory 332 and the head section 334 such that the second memory 332 and the head section 334 record information on the write-once recording medium 100 and further, the second memory 332 and the head section 334 reproduce the information from the write-once recording medium 100.

The system control section 321 and the drive control section 331 may be realized an integrated circuit such as an LSI. Alternatively, they can be realized by a general processor and a memory (e.g., ROM). In the memory (e.g., ROM), a program executable by a computer (e.g., general processor) is stored. This program represents a recording process and a reproduction process which have been described above and will be also described later. The computer (e.g., general computer) executes the recording process and the reproduction process according to the present invention in accordance with this program.

1-4. Recording Procedure

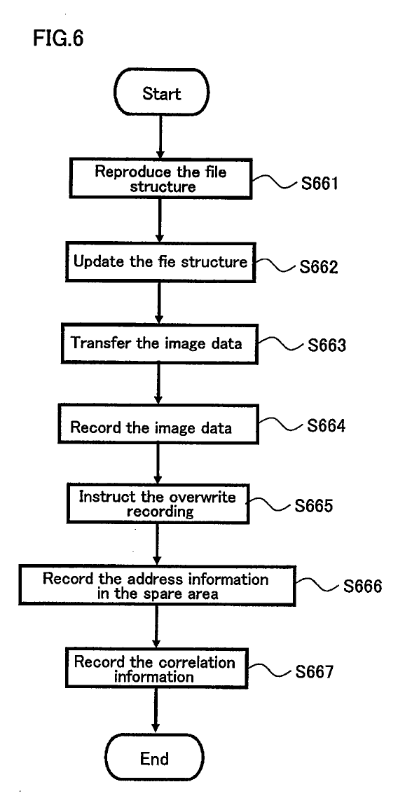

FIG. 6 shows a recording procedure according to Embodiment 1 of the present invention. The recording procedure is realized by the recording/reproduction apparatus 300A.

Hereinafter, the recording procedure according to Embodiment 1 of the present invention will be described step by step with reference to FIGS. 2, 3, 4, 5 and 6.

When the steps which will be described below are performed, the recording/reproduction apparatus 300A records the second user file 406 on the write-once recording medium 100 having the data structure which has been described with reference to FIG. 2 and creates the write-once recording medium 100 having the data structure which has been described with reference to FIG. 3.

Step S661: The system control section 321 of the computer system 320 instructs the drive control section 331 of the drive apparatus 330 to reproduce the first file structure 403 included in the first image data 401. The system control section 321 receives the reproduced first file structure 403 and stores the first file structure 403 in the file structure operation area 325 included in the first memory 322.

Step S662: The system control section 321 prepares the second user file 406. The second user file 406 is generated, based on the first user file 405 included in the first image data 401, by an editing work by a user. Then, the system control section 321 updates the first file structure 403 stored in the file structure operation area 325 so as to generate the second file structure 404 related to the recording of the second user file 406.

Step S663: The system control section 321 transfers the second image data 402, which includes the second file structure 404 and the second user file 406, from the computer memory 324 to the second memory 332 of the drive apparatus 330 via the data file area 326.

Step S664: The drive control section 331 of the drive apparatus 330 controls the head section 334 such that the head section 334 records the second image data 402 in an empty area of the write-once recording medium 100.

Step S665: The computer system 320 updates the first address information 407 in accordance with the updating from the first image data 401 to the second image data 402 so as to generate the second address information 408 (i.e., address information including location information indicating a location of the file structure 404) in the second memory 332. Then, the computer system 320 instructs the drive apparatus 330 to perform an overwriting of the second address information 408. In other words, the computer system 320 instructs the drive apparatus 330 to record the second address information 408 at logical address “i” of the first address information 407.

Step S666: Since at the indicated location (logical address “i”), the first address information 407 is already recorded, the drive apparatus 330 records the second address information 408 in the inner spare area 106.

Step S667: The drive control section 331 of the drive apparatus 330 generates, in the second memory 332, correlation information 409 for correlating the first address information 407 and the second address information 408. The drive control section 331 records the correlation information 409 in the lead-in area 101 of the write-once recording medium 100.

After the correlation information 409 is recorded in the lead-in area 101, the process is completed.

In the recording procedure which has been described with reference to FIG. 6, the first file structure 403 to which logical addresses are assigned are read from the write-once recording medium 100 to the file structure operation area 325 of the first memory 322. Thus, it is no longer necessary for the computer system 320 to convert the file structure to which the physical addresses are assigned to the file structure to which the logical addresses are assigned. As a result, even when the computer system 320 does not have a function of converting the file structure to which the physical addresses are assigned to the file structure to which the logical addresses are assigned, the file structure can be updated and rewritten.

As described in the recording procedure of Embodiment 1 of the present invention, the recording apparatus of the present invention includes a host apparatus and drive apparatus. The present invention can generate correlation information for correlating first information and second information by the drive apparatus and record the second information and the correlation information on a write-once recording medium. Therefore, it is possible to record the correlation information on the write-once recording medium without having the correlation information being generated by the host apparatus. As a result, on the logical space, this file structure is the same as the read-only file structure. Thus, it is possible to reproduce data in the write-once recording medium even in a system which only can perform a reproduction operation for read-only recording medium or rewritable recording medium.

1-5. Reproduction Procedure

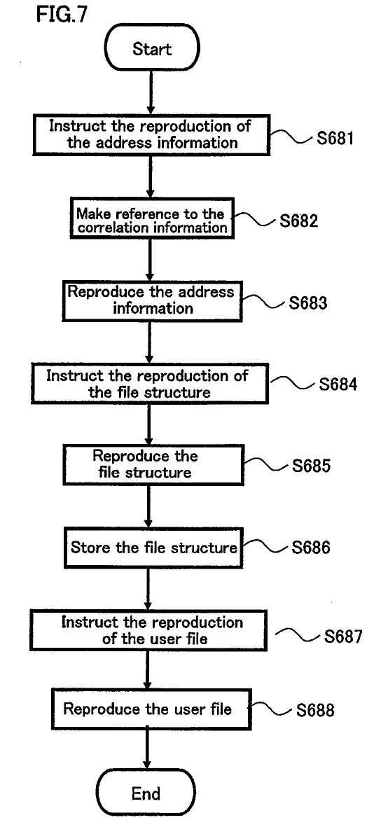

FIG. 7 shows a reproduction procedure according to Embodiment 1 of the present invention. The reproduction procedure is realized by the recording/reproduction apparatus 300A.

Hereinafter, the reproduction procedure according to Embodiment 1 of the present invention will be described step by step with reference to FIGS. 2, 3 and 7. When the steps which will be described below are performed, the recording/reproduction apparatus 300A reproduces the second user file 406 from the write-once recording medium 100 having the data structure which has been described with reference to FIG. 3.

Step S681: The system control section 321 of the computer system 320 specifies logical address “i” of the first address information 407 and instructs the drive apparatus 330 to reproduce the first address information 407.

Step S682: The drive control section 331 of the drive apparatus 330 converts logical address “i” to physical address “C” and then reads out the correlation information 409 so as to check whether there is a physical address value correlated to physical address “C”.

The correlation information 409 correlates physical address “C” corresponding to logical address “i” where the first address information 407 is recorded and physical address “K” where the second address information 408 is recorded. Accordingly, the drive control section 331 reads out the correlation information 409 so as to detect that the physical address value “K” is correlated to the physical address value “C”.

The correlation information 409 may correlate logical address “i” of the first address information 407 and physical address “K” of the second address information 408. If logical address “i” directly corresponds to physical address value “K”, the conversion from logical address “i” to physical address value “C” is not necessary. Even when logical address “i” of the first address information 407 and physical address “K” of the second address information 408 are correlated to each other, the correlation information 409 can be regarded as the information correlating the first address information 407 and the second address information 408.

Step S683: The drive control section 331 reproduces information recorded in physical address “K” (i.e., second address information 408) and transfers the information to the computer system 320.

Step S684: The system control section 321 of the computer system 320 obtains logical address indicating a recording location of the second file structure 404 (i.e., “n”) from the transferred second address information 408. Then, the system control section 321 instructs the drive apparatus 330 to reproduce the second file structure 404.

Step S685: The drive control section 331 of the instruction-received drive apparatus 330 controls the head section 334 such that the head section 334 reproduces the second file structure 404. The drive control section 331 transfers the reproduced second file structure 404 to the computer system 320.

Step S686: The second file structure 404 which has been transferred is stored in the file structure operation area 325 of the computer system 320.

Step S687: The system control section 321 of the computer system 320 obtains a recording location of the second user file 406 based on the second file structure 404 stored in the file structure operation area 325. Then, the system control section 321 instructs the drive apparatus 330 to reproduce the second user file 406 based on the recording location of the second user file 406.

Step S688: The drive control section 331 of the instruction-received drive apparatus 330 controls the head section 334 such that the head section 334 reproduces the second user file 406 based on the location of the reproduction-instructed second user file 406. The drive control section 331 transfers the reproduced second user file 406 to the computer system 320.

The computer system 320 stores the received user file 406 in the first memory 322 or in the computer memory 324. Then, the computer system 320 reproduces the user file 406 and performs a displaying of an image and/or a outputting of a sound. Alternatively, the computer system 320 reproduces the user file 406 and performs an editing of the video data or the audio data.

After the user file 406 is reproduced, the process is completed.

According to the reproduction procedure of Embodiment 1 of the present invention, only if the computer system 320 instructs the drive apparatus 330 to reproduce the first address information 407 recorded in predetermined logical address “i”, address information indicating a location of the latest file structure (herein, second address information 408 indicating the location of the second file structure 404) can be obtained.

As described in the reproduction procedure of Embodiment 1 of the present invention, the recording apparatus of the present invention includes a host apparatus and drive apparatus and can reproduce second information from the write-once recording medium based on correlation information for correlating first information and the second information by the drive apparatus. Therefore, it is possible to reproduce the second information from the write-once recording medium by the drive apparatus without instructing to reproduce the second information by the host apparatus. As a result, on the logical space, this file structure is the same as the read-only file structure. Thus, it is possible to reproduce data in the write-once recording medium even in a system which only can perform a reproduction operation for read-only recording medium or rewritable recording medium.

The recording procedure and the reproduction procedure according to Embodiment 1 of the present invention have been described with reference to FIGS. 2 to 7.

According to the recording procedure and the reproduction procedure according to Embodiment 1 of the present invention, the computer system 320 instructs the drive apparatus 330 to perform an updating and overwriting of the first address information 407 in order to record the second user file 406. Then, the computer system 320 instructs the drive apparatus 330 about logical address “i” of the first address information 407 in order to reproduce the second user file 406. In practice, it is possible to obtain the second address information 408 by the drive apparatus 330 which has referred to the correlation information 409. It is possible to reproduce the second user file 406 based on the second address information 408. In other words, in the computer system 320, the second address information 408 is overwritten at a recording location of the first address information 407 (pseudo-overwrite recording).

1-6. Empty Area Management

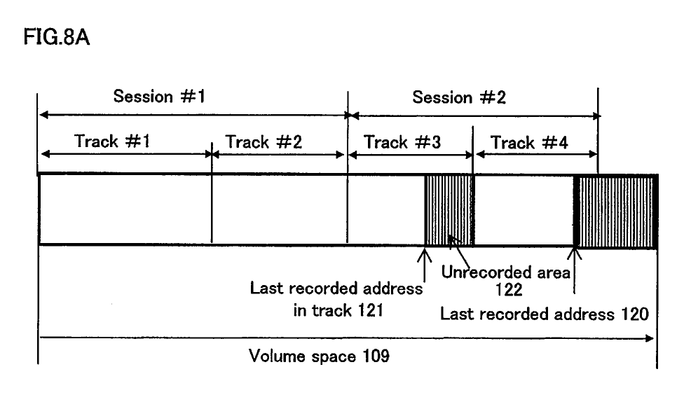

FIG. 8 shows an empty are included in the user area 108. The management of user data which is to be recorded in the user area 108 is performed by making reference to a file system. The space managed by making reference to the file system is referred to as the volume space 109.

In the volume space 109, regarding a method for managing the empty area (area where data is not recorded), there are empty area management by a sequential recording method and empty area management by a random recording method, for example.

FIG. 8A is a view for describing the empty area management by the sequential recording method. In the volume space 109 shown in FIG. 8A, a plurality of sessions (e.g., session #1 and session #2) are allocated. Each of the plurality of sessions includes at least one track. The track is formed as a contiguous area included in the write-once recording medium 100 and is managed by track management information. The session is managed by session management information.

For example, the session #1 includes track #1 and track #2, and the session #2 includes track #3 and track #4. The track #3 includes a recorded area and an unrecorded area 122. The boundary between the recorded area and the unrecorded area 122 is a last recorded address in track 121. In the track #3, unrecorded area 122 after the last recorded address in track 121 is an empty area. The data can be recorded in the unrecorded area 122. A track where data can be recorded is referred to as recordable track. The track #4 includes a recorded area and an unrecorded area. The boundary between the recorded area and the unrecorded area is a last recorded address 120.

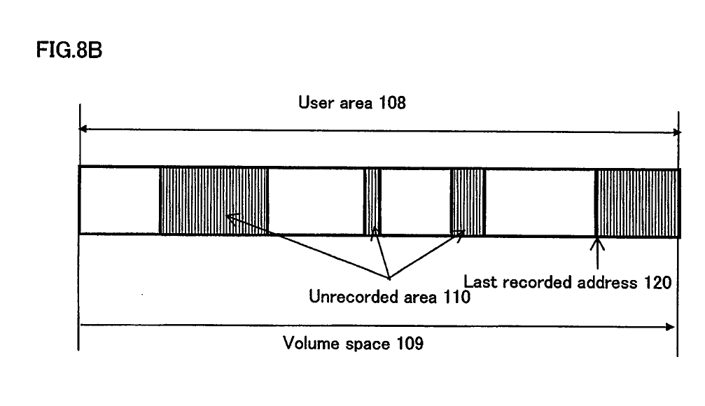

Hereinafter, the empty area management by the sequential recording method will be described with reference to FIGS. 8A, 9A and 9B.

FIG. 9 shows a data structure of information to be recorded in the disk management information area (see FIG. 1B). The disk management information is recorded in the disk management information area. The disk management information includes replacement information, session management information 200, track management information 210 and space bitmap management information 220.

FIG. 9A shows a data structure of the session management information 200. The session management information 200 includes header information 201 and a plurality of track management information (track management information #1, #2, #3, #4). The header information 201 includes an identifier of the session management information 200 and information 202 indicating the number of the plurality of track management information 210. The header information 201 includes, for example, information indicating track number (recordable track numbers 203, 204) of a recordable track (or open track). Information indicating the track number of the track having a state where data cannot be recorded (i.e., non-recordable track or closed track) for some reason (e.g., no presence of unrecorded area, an instruction from a user and the like) is not included in the header information 201. The plurality of track management information (track management information #1, #2, #3, #4) corresponds to a plurality of tracks (tracks #1, #2, #3, #4) (see FIG. 8A), respectively.

FIG. 9B shows a data structure of one of the plurality of track management information 210. The track management information 210 includes session start information 211 indicating whether a corresponding track is a leading track of the session; track start location information 212 indicating start location of the track; and last recorded address information 213 indicating a location at which data has been recorded last within the track.

If a track managed by the track management information 210 is located at a leading position of the session, information having a value indicating such (e.g., “1”) is set to the session start information 211. If a track managed by the track management information 210 is not located at a leading position of the session, information having a different value (e.g., “0”) is set to the session start information 211.

The track start location information 212 is, for example, a physical address showing a start location of a corresponding track.

The last recorded address information 213 is, for example, a last recorded physical address indicating a location at which data has been recorded last in the corresponding track. In FIG. 8A, the last recorded address in track 121 is such an example. It is possible to recognize an empty area on the write-once recording medium 100 by checking the recordable track number and the last recorded address information 213.

In the present embodiment, it is possible to record data for each track. The data recording is performed from a leading position of each of a plurality of tracks. The data is continuously allocated within the track. Once the data has been recorded, the last recorded address information 213 is updated to indicate the last recorded address.

When the data recording is performed next time, the latest value of the last recorded address information 213 is checked. As a result, it is possible to recognize the next recording start location. In general, the next recording start location is a physical sector which is next to the physical sector indicated by the last recorded address information 213. Alternatively, when the data recording is made as a minimum unit of ECC block with respect to the write-once recording medium 100, the next recording start location may be within an ECC block which is next to the ECC block including the physical sector indicated by the last recorded address information 213.

In one embodiment of the present invention, there is a method for avoiding the consumption of the spare area during recording data. When the data recording is performed as a unit of a sector on the write-once recording medium having a pseudo-overwriting function, the actual data recording is performed as a unit of an ECC block. For example, when the data recording for one sector is performed in a case where one ECC block includes 32 sectors, one ECC block is consumed. Specifically, one ECC block including the sector to be recorded is read, and then one ECC block, to which data is to be recorded is added, is instructed to be pseudo-overwritten. As a result, the data of this ECC block is recorded in the spare area. In the present invention, the data is recorded from a leading position of an ECC block which is the next to the ECC block including the last recorded location so that the ECC block at which the data has been already recorded is not used. As a result, the consumption of the spare area can be avoided.

FIG. 8B is a view for describing the empty area management by the random recording method. The volume space 109 shown in FIG. 8B randomly includes a plurality of recorded recording areas and a plurality of unrecorded areas 110. The boundary between the last area of the plurality of recorded recording areas the last area of the plurality of unrecorded areas 110 is the last recorded address 120.

The empty area management by the random recording method will be described with references to FIGS. 1, 8, 9C and 10.

When recorded sectors (or ECC blocks) are managed, it is possible to record data at an arbitrary location (physical address) on the write-once recording medium 100 (a kind of random recording). In order to realize the random recording, it is necessary to manage the empty area and the last recorded address on the write-once recording medium 100. For example, the empty area and the last recorded address are managed based on the disk management information. The disk management information is recorded in a first disk management information area 104 or a second disk management information area 105.

The disk management information to be recorded in the second disk management information area 105 may be duplication of the disk management information recorded in the disk management information area 104 or a portion of the disk management information which cannot be stored in the disk management information area 104.

FIG. 9C shows a data structure of the space bitmap management information 220. The space bitmap management information 220 is included in the disk management information recorded in the first disk management information area 104. The space bitmap management information 220 includes header information 221, managed area information 222 and space bitmap information 223.

The header information 221 is general information such as an identifier of the space bitmap management information 220. The managed area information 222 indicates a managed area. The managed area includes a plurality of sectors included in the user area 108. The unrecorded/recorded status of the plurality of sectors is managed by the managed area information 222. For example, the managed area information 222 indicates a start location or length of the managed area. The space bitmap information 223 indicates whether each of the plurality of sectors included in the managed area is unrecorded or recorded. For example, one bit of data is assigned to each of the plurality of sectors. If the sector is unrecorded, the one bit of data is “0”. If the sector is recorded, the one bit of data is “1”. Thus, it is possible to manage the unrecorded/recorded status for every sector in the managed area by the space bitmap information 223.

As described with reference to FIGS. 9A and 9C, it is possible to manage the unrecorded/recorded status for each sector on the write-once recording medium 100 by the use of either the session management information 200 or the space bitmap management information 220. Accordingly, either one of the session management information 200 or the space bitmap management information 220 can be selectively used according to the purpose of use of the write-once recording medium 100. Alternatively, both the session management information 200 and the space bitmap management information 220 can be used.

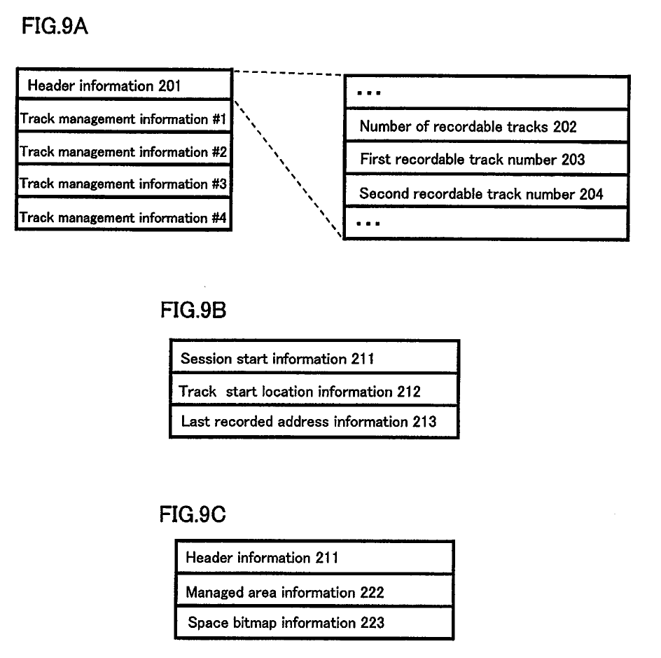

FIG. 10 shows a data structure of disk structure information 1100. The disk structure information 1100 is included in the disk management information.

The disk structure information 1100 is recorded in a last recorded address information 1107 indicating the last recorded address 120 and recording mode information 1106. The recording mode information 1106 includes information indicating the empty area management method (e.g., at least one of the session management information 200 and the space bitmap management information 220).

The disk structure information 1100 further includes general information 1101; replacement management information list location information 1102 indicating a location of the latest replacement management information list 1000; user area start location information 1103 indicating a start location of the user area 108; user area end location information 1104 indicating end location of the user area 108; and spare area information 1105 indicating the capacity of the inner spare area 106 and the outer spare area 107; and spare area management information 1108 indicating areas available for replacing the inner spare area 106 and the outer spare area 107.

It is possible to change the capacity of the inner spare area 106 and the outer spare area 107 depending on the write-once recording medium 100 based on the spare area information 1105. For example, it is possible designate the capacity of the inner spare area 106 and the outer spare area 107 to 0.

The disk structure information 1100 further includes session management information location information 1109 indicating a location of the latest session management information 200; and space bitmap management information location information 1110 indicating a location of the latest space bitmap management information 220.

Embodiment 1 according to the present invention has been described with reference to FIGS. 1 to 10.

According to Embodiment 1 of the present invention, the computer system 320 can correctly reproduce the user file 406 which is the latest information (second user file) 406 from the write-once recording medium 100 by reading out the correlation information 409 from the write-once recording medium by the drive apparatus 330 even when the computer system 320 is a system which can only perform a reproduction operation for read-only recording medium or rewritable recording medium. By processing the correlation information 409 by the drive apparatus 330, the reproduction procedure for directories and/or files in the computer system 320 can be completely the same as the read-only or rewritable reproduction procedure and thus, broad compatibility with the computer system 320 can be realized. As described above, according to the present invention, the write-once information recording media has reproduction compatibility with a system which can only perform a reproduction operation for read-only recording medium or a rewritable recording medium.

Furthermore, according to Embodiment 1 of the present invention, the pseudo-overwrite recording is performed not for all the data recorded in the logical addresses, but only for particular information (e.g., management information for the files and directory information) and the like. Therefore, a capacity of the correlation information 409 required for pseudo-overwrite recording can be limited to a predetermined capacity. As a result, it is easy to implement the drive apparatus 330.

Still further, according to Embodiment 1 of the present invention, if it is not possible to perform a recording on an area where data is recorded due to factors such as a defect, a scratch and the like, provided that the this is immediately after the recording process, the data can be correctly re-written using the pseudo-overwrite recording. In a conventional medium such as a CD-R disk or the like, if there is an error in writing, the disk cannot be re-used. However, according to the present invention, it is possible to correct the error in writing. As a result, the cost of manufacturing write-once recording media can be reduced, thereby providing a significant merit in the industrial aspect. For example, it has been required that there is no defect on write-once recording media when the write-once recording media are manufactured. However, when the present invention is used, it is possible to lower the quality of the write-once recording media at the time of manufacturing and thus, it is possible to further reduce the cost of manufacturing the write-once recording media.

### 2. Embodiment 2

Hereinafter, Embodiment 2 according to the present invention will be described with reference to the accompanying drawings. Pseudo-overwrite recording and empty area management in Embodiment 2 according to the present invention can be realized by using methods similar to those described in “1-2. Pseudo-overwrite recording” and “1-6. Empty area management” according to Embodiment 1 of the present invention, and thus, the description thereof will be omitted herein.

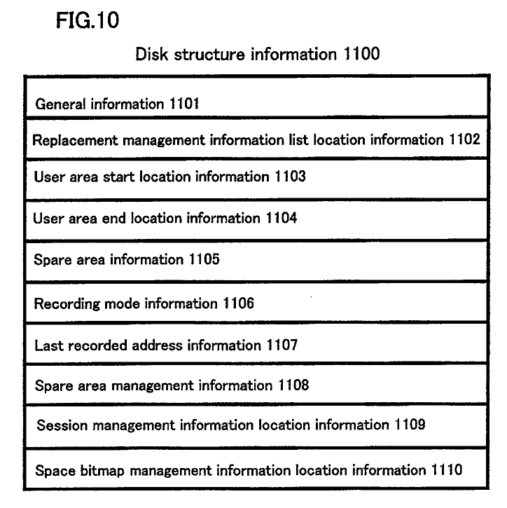

FIG. 11 shows an example of a file and directory tree structure recorded on the write-once recording medium 100. In the description to be made below, the volume/file structure making up the file system has, for example, a data structure defined by ISO/IEC13346 standard or UDF (Universal Disk Format) specification. Further, the metadata partition and the metadata file have a data structure defined by version 2.5 of the UDF specification.

Directory (Dir-A) and directory (Dir-B) are recorded immediately below ROOT directory of the write-once recording medium 100. Data file (File-a) is recorded immediately below the directory (Dir-A), and data file (File-b) is recorded immediately below the directory (Dir-B).

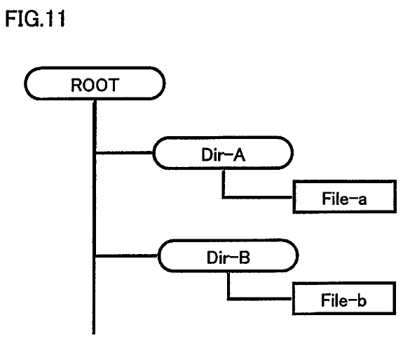

FIG. 12 shows another example of a data structure of the write-once recording medium 100. In FIG. 12, the same reference numbers are denoted to the areas which have been described with reference to FIGS. 1 and 2, and the description thereof will be omitted. On the write-once recording medium 100 which will be described with reference to FIG. 12, the file and directory tree structure which has been described with reference to FIG. 11 are recorded.

A main volume structure area 410, a physical partition 420 and a reserve volume structure area 411 are allocated to the volume space 109. In the physical partition 420, a first metadata partition 430 and a second metadata partition, which are defined by version 2.5 of the UDF specification, are allocated. First image data 500 is recorded in the physical partition 420.

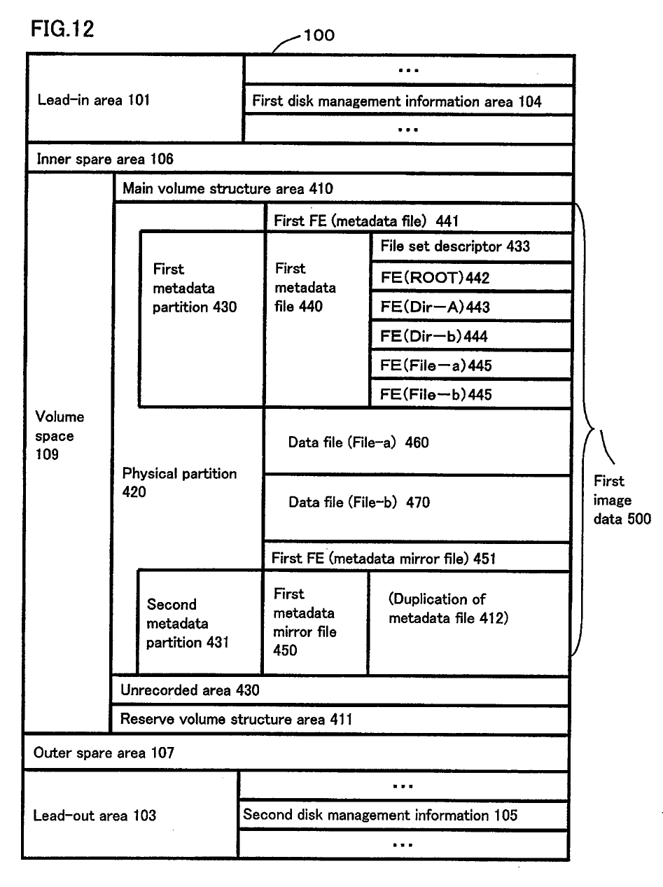

FIG. 13 shows an example of a data structure of the first image data 500. Hereinafter, the example of the data structure of the first image data 500 will be described with reference to FIGS. 12 and 13. The image data 500 is generated by integrating the file and directory tree structure (see FIG. 11) and the latest file management information for managing the file and directory tree structure into one file.

The first image data 500 includes: a first metadata file 440 recorded in the first metadata partition 430; first FE (file entry) (metadata file) 441 which is file entry (FE) indicating a recording location of the first metadata file 440; a first metadata mirror file 450 recorded in the second metadata partition 431; first FE (metadata mirror file) 451 which is file entry (FE) indicating a recording location of the first metadata mirror file 450; data file (File-a) 460; and data file (File-b) 470.

The first metadata mirror file 450 is duplication of the first metadata file 440. Information of the file structure (FE, directory file and the like) is all included in the first metadata file 440. It is preferable to locate the first metadata file 440 and the first metadata mirror file 450 apart from each other in order to avoid the destruction of the file management information due to some reason (e.g., any scratch on the recording medium).

Each of the first metadata file 440 and the first metadata mirror file 450 includes, as the file management information, a file set descriptor 433, FE (ROOT) 442, FE (Dir-A) 443, FE (Dir-b) 444, FE (File-a) 445 and FE (File-b) 445.

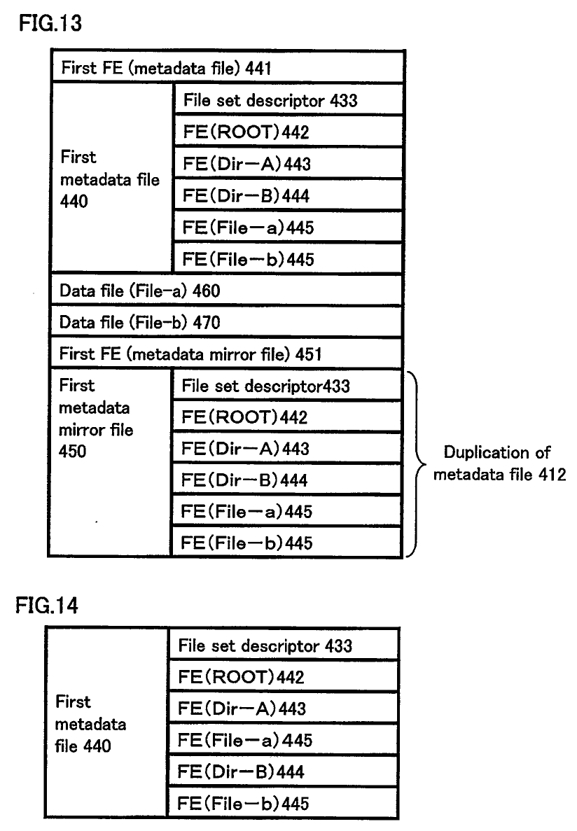

FIG. 14 shows another example of a data structure of the first metadata file 440. In another example, the file management information is arranged in view of the directory tree. In other words, the directory (Dir-A) is followed by the data file (File-a) under the directory (Dir-A), and the directory (Dir-B) is followed by the data file (File-b) under the directory (Dir-B).

The arrangement of data shown in FIG. 14 makes it possible to efficiently access the data in a particular application.

A directory tree for recording data for a particular application (e.g., TV program recording) is first determined and then, files and directories below the directory are arranged in its neighborhood. Padding data (e.g., data having all zeros) may be recorded between the plurality of FEs (metadata file) such that each of the plurality of FEs is arranged at a leading position of an ECC block. Furthermore, padding data (e.g., data having all zeros) may be recorded between the FE and the metadata file.

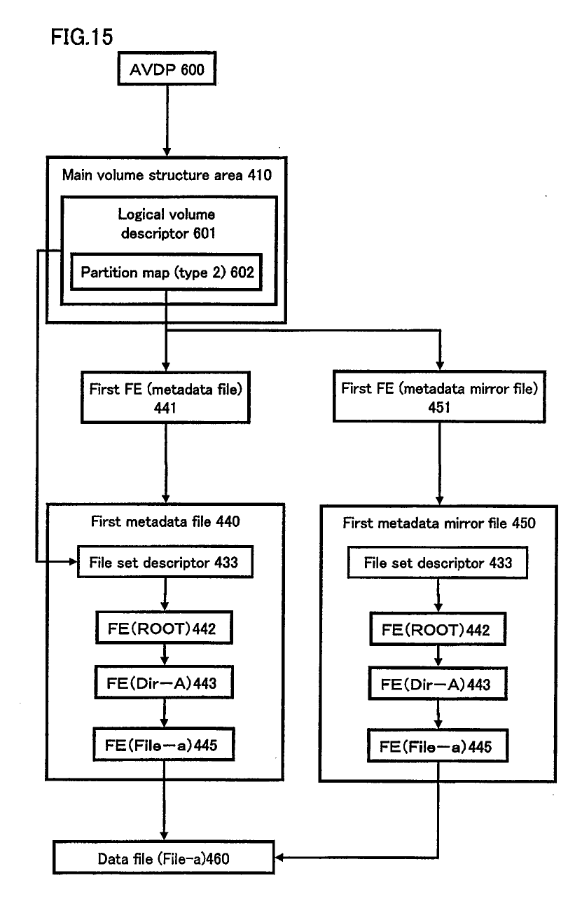

FIG. 15 shows the reference relationship between data included in the volume structure and the file structure, respectively. Hereinafter, the reference relationship between data included in the volume structure and the file structure, respectively, will be described with reference to FIGS. 13 and 15.

The volume structure and the file structure defined by the UDF specification has an anchor volume descriptor pointer 600 (hereinafter, referred to as AVDP 600), which indicates a location address information, as a start point. The AVDP 600 is recorded at a predetermined location on the write-once recording medium 100. The ADVP indicates, for example, a recording location of the main volume structure area 410.

In the main volume structure area 410, a logical volume descriptor 601 is recorded. The logical volume descriptor 601 indicates a recording location of a file set descriptor 433 recorded in the first metadata partition 430.

By making reference to the recording location information of the file set descriptor 433, the file structure can be retrieved so as to access the data file (File-a) 460, for example.

In the first metadata mirror file 450, the duplication of the first metadata file 440 is recorded. Accordingly, by making reference to the metadata mirror file 450, it is also possible to read out the data file (File-a) 460.

The logical volume descriptor 601 includes a partition map (type 2) 602. The partition map (type 2) 602 includes a recording location of the first FE (metadata file) 441 and the first FE (metadata mirror file) 451.

The first FE (metadata file) 441 indicates a recording location of the first metadata file 440. By making reference to the first FE (metadata file) 441, the allocation location of the first metadata partition 430 may be detected.

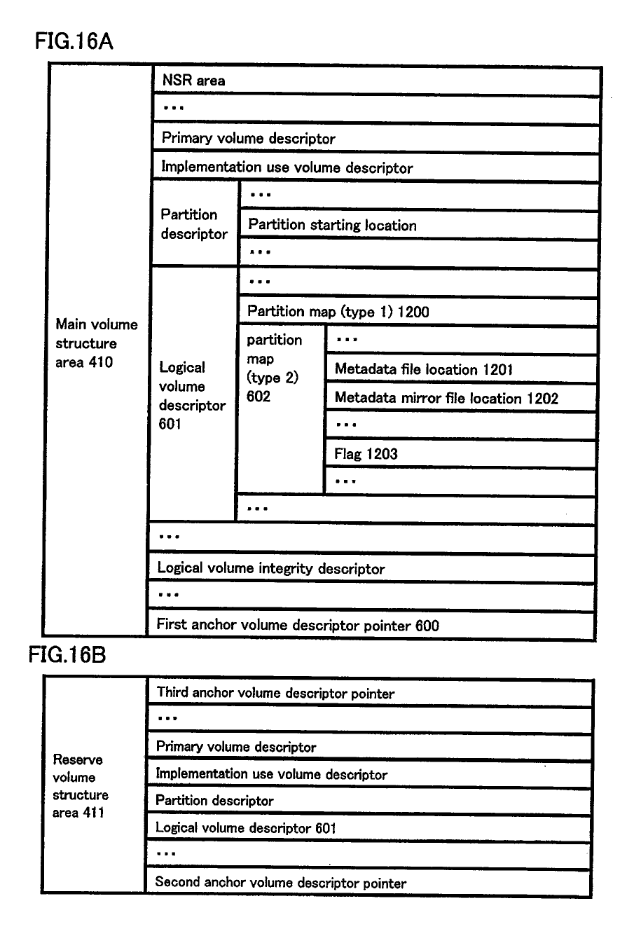

FIG. 16A shows an example of a data structure of the main volume structure area 410. In the main volume structure area 410, the logical volume descriptor 601 and an anchor volume descriptor pointer 600 are recorded.

The logical volume descriptor 601 includes a partition map (type 1) 1200, metadata file location in-formation 1201, metadata mirror file location information 1202 and a flag 1203.

The partition map (type 1) 1200 is information for managing the physical partition. The metadata file location information 1201 indicates a location of the first FE (metadata file) 441. The metadata mirror file location information 1202 indicates a location of the first FE (metadata mirror file) 451. The flag 1203 indicates whether the first metadata mirror file 450 is recorded on the write-once recording medium 100, wherein the first metadata mirror file 450 is an optional function of the UDF specification.

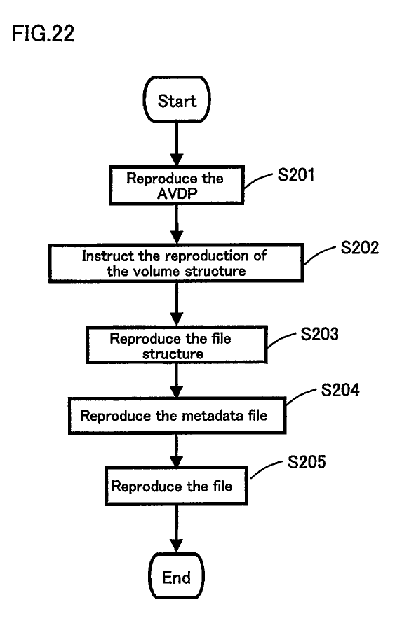

FIG. 16B shows an example of a data structure of the reserve volume structure area 411. In the reserve volume structure area 411, information similar to the information recorded in the main volume structure area 410 is recorded (see FIG. 22A). In the reserve volume structure area 411, for example, a second anchor volume descriptor pointer and a third anchor volume descriptor pointer are recorded.

In the data structure of the main volume structure area 410 and the reserve volume structure area 411, it is possible to arrange dummy data (e.g., 00h) so that the partition of the data structure matches with the boundary of the ECC blocks. Further, for example, it is possible to arrange each anchor volume descriptor pointer, the primary volume descriptor, the logical volume descriptor 601 and the logical volume integrity descriptor, which are included in the main volume structure area 410 and the reserve volume area 411, from a leading position of the ECC block. Further, it is possible to assign a plurality of tracks to the user area 108 and record the each of the plurality of anchor volume descriptors in the plurality of tracks.

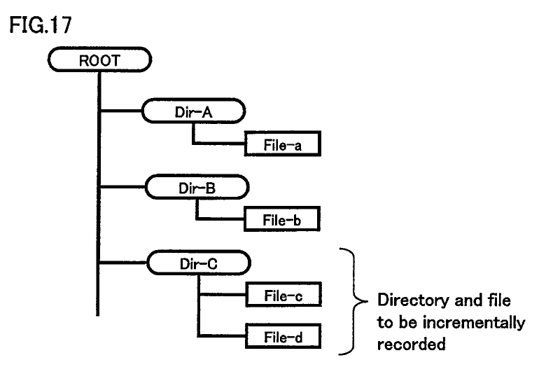

FIG. 17 shows an example of a file and directory tree structure recorded on the write-once recording medium 100.

In the file and directory tree structure shown in FIG. 17, directory (Dir-C) is recorded immediately below the ROOT directory of the write-once recording medium for the file and directory tree structure shown in FIG. 11. Immediately below the directory (Dir-C), data file (File-c) and data file (File-d) are recorded.

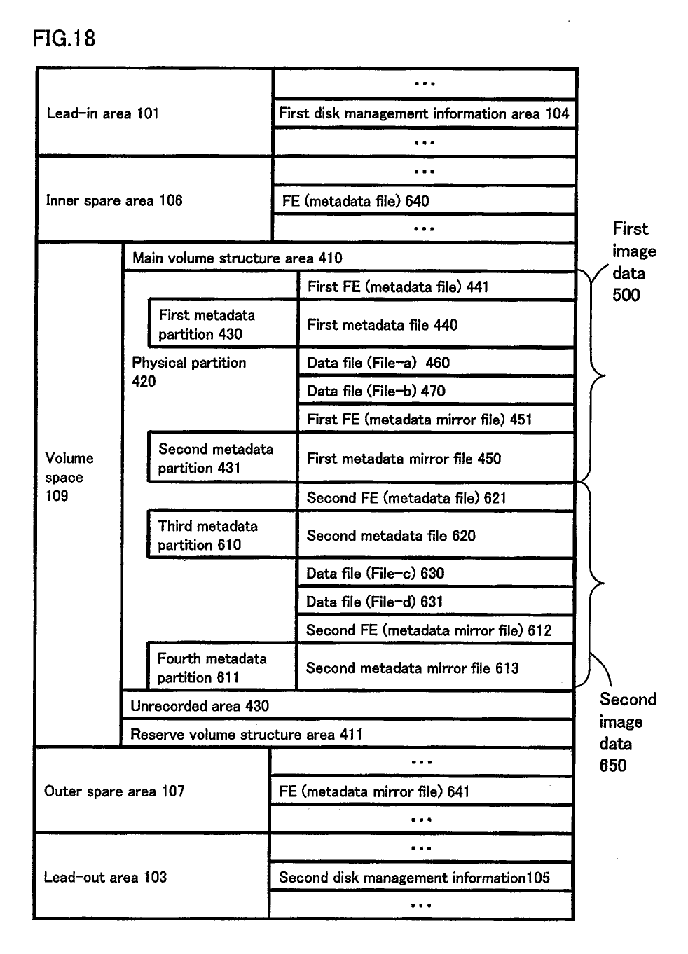

FIG. 18 shows another example of a data structure of the write-once recording medium 100. In FIG. 18, the same reference numbers are denoted to the areas which have been described with reference to FIGS. 1 and 12, and the description thereof will be omitted. In the write-once recording medium 100 which will be described with reference to FIG. 18, the file and directory tree structure described with reference to FIG. 17 are recorded.

In a physical partition 420 allocated to the volume space 109, second image data 650 is recorded.

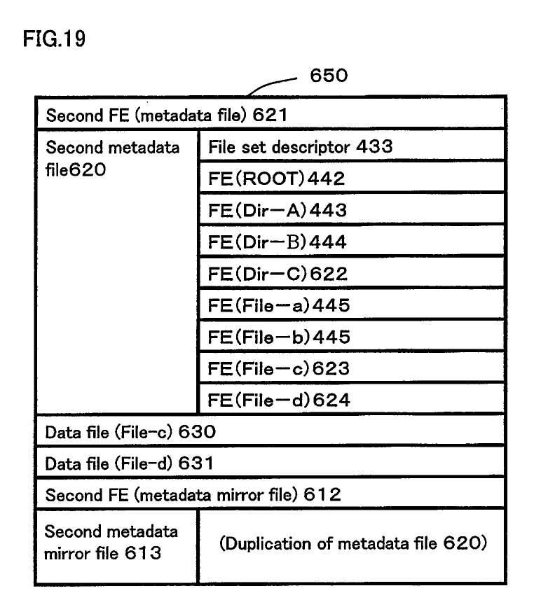

FIG. 19 shows an example of a data structure of the second image data 650. Hereinafter, the example of the data structure of the second image data 650 will be described with reference to FIGS. 18 and 19.

The second image data 650 includes second FE (metadata file) 621, a second metadata file 620, a data file (File-c) 630, a data file (File-d) 631, second FE (metadata mirror file) 612 and a second metadata mirror file 613. The second metadata file 620 includes file management information FE (Dir-C)) 622 for the directory (Dir-C), the data file (File-c) and the data file (File-d), FE (File-c) 623 and FE (File-d) 624. The second metadata mirror file 613 includes duplication data of the second metadata file 620.

The FE (metadata file) 621 is recorded as the FE (metadata file) 640 in the spare area 106. The FE (metadata file) 640 indicates a recording location of the second metadata file 620. Further, replacement information included in the disk management information recorded in the first disk management information area 104 is updated, and the first FE (metadata file) 441 is mapped to the FE (metadata file) 640. Further, in a similar manner, the pseudo-overwrite recording is performed on the first FE (metadata mirror file) 451, and the first FE (metadata mirror file) 451 is mapped to the FE (metadata mirror file) 641.

It is desirable to record the FE (metadata mirror file) 640 and the FE (metadata mirror file) 641 in the different spare areas. The FE (metadata mirror file) 641 is duplication data of the FE (metadata mirror file) 640. The FE (metadata mirror file) 641 is data in case the FE (metadata mirror file) 640 is damaged. When the FE (metadata mirror file) 640 and the FE (metadata mirror file) 641 are physically recorded in the different spare areas, resistance against the data damage is improved.

In order to realize the pseudo-overwrite recording, it is desirable that the capacity of the second spare area 107 is greater than or equal to that of the inner spare area 106. The capacity of the inner spare area 106 and the capacity of the second spare area 107 are indicated by the spare area information 1105.

2-2. Recording/Reproduction Apparatus

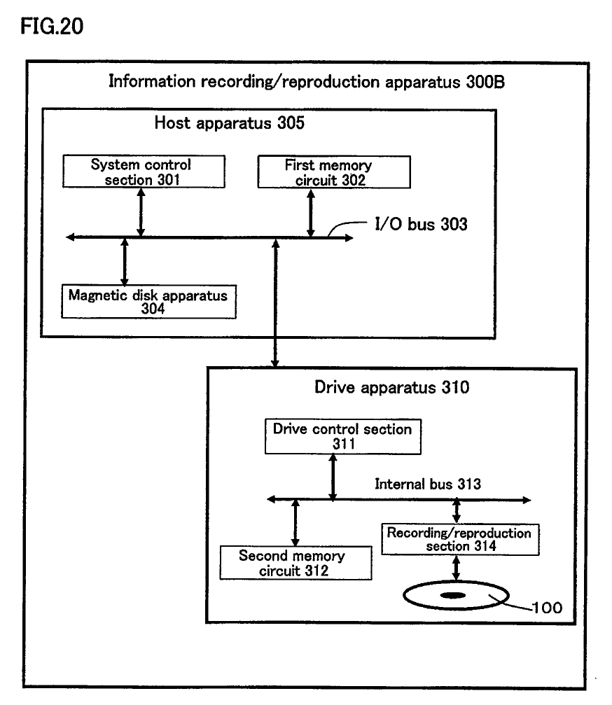

FIG. 20 shows an information recording/reproduction apparatus 300B according to Embodiment 2 of the present invention. The information recording/reproduction apparatus 300B realizes pseudo-overwrite recording (see “1-2. Pseudo-overwrite recording”). The information recording/reproduction apparatus 300B includes a host apparatus 305 and a drive apparatus 310. The host apparatus may be, for example, a computer system or a personal computer. The information recording/reproduction apparatus 300B functions as one of a recording apparatus, a reproduction apparatus and a recording/reproduction apparatus. The host apparatus 305 includes a system control section 301, a first memory circuit 302, a magnetic disk apparatus 304 and an I/O bus 303. Data is transferred between the host apparatus 305 and the write-once recording medium 100 via the drive apparatus 310.

The system control section 301 controls the first memory circuit 302 and the magnetic disk apparatus 304. For example, the system control section 301 controls the first memory circuit 302 such that the first memory circuit 302 transfers data to both the magnetic disk apparatus 304 and the drive apparatus 310.

The system control section 301 includes a microprocessor which includes a memory for computation and performs a system control program. For example, the system control section 301 performs a recording/reproduction of a volume structure/file structure of a file system, recording/reproduction of a metadata partition/file structure, recording/reproduction of a file and recording/reproduction of data for a lead-in/lead-out area.

The first memory circuit 302 is used to compute or temporarily store the volume structure, the file structure, the metadata partition/file structure and the file.

The drive apparatus 310 includes a drive control section 311, a second memory circuit 312, an internal bus 313 and a recording/reproduction section 314. The recording/reproduction section 314 may be, for example, a head section. The drive apparatus 310 is structured so as to be able to mount the write-once recording medium 100 thereon. The drive apparatus 310 transfers data to and from the write-once recording medium 100.

The drive control section 311 includes a micro-processor which includes a memory for computation and performs a drive control program. The drive control section 311 performs a controlling for the process on recording/reproduction of data for the disk management information area and the spare area and pseudo-overwrite recording/reproduction; and perform a computation. The drive control section 311 controls the second memory circuit 312 and the recording/reproduction section 314. For example, the drive control section 311 controls the second memory circuit 312 and the recording/reproduction section 314 such that the second memory control circuit 312 and the recording/reproduction section 314 record information on the write-once recording medium 100 and further, the second memory circuit 312 and the recording/reproduction section 314 reproduce the information from the write-once recording medium 100.

The system control section 301 and the drive control section 311 may be realized an integrated circuit such as an LSI. Alternatively, they can be realized by a general processor and a memory (e.g., ROM). In the memory (e.g., ROM), a program executable by a computer (e.g., the general processor) is stored. This program represents a reproduction process and a recording process which have been described above and will be also described later. The computer (e.g., general computer) executes the reproduction process and the recording process according to the present invention in accordance with this program.

2-3. Recording Procedure

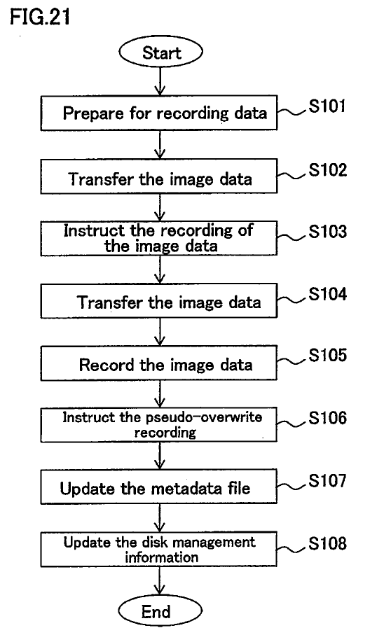

FIG. 21 shows a recording procedure according to Embodiment 2 of the present invention. The recording procedure is realized by the recording/reproduction apparatus 300B.

Hereinafter, the recording procedure according to Embodiment 2 of the present invention will be described step by step with reference to FIGS. 12, 18, 20 and 21.

When the steps which will be described below are performed, the recording/reproduction apparatus 300B records the second image data 650 on the write-once recording medium 100 having the data structure which has been described with reference to FIG. 12 and creates the write-once recording medium 100 having the data structure which has been described with reference to FIG. 18.

Step S101: Prior to the recording of the second image data 650, the system control section 301 of the host apparatus 305 and the drive control section 311 of the drive apparatus 310 read out the data, which is required in order to record/reproduce data, from the disk management area and the like on the write-once recording medium 100. For example, for recording the first image data 500, the first image data 500 is previously created in the magnetic disk apparatus 304. Then, information respectively included in the main volume structure area 410 and the reserve volume structure area 411 is recorded. Thereafter, when the first image data 500 is recorded in the volume space 109, the data structure shown in FIG. 12 is realized. The reserve volume structure area 411 may be recorded after recording the first image data 500.

Step S102: The system control section 301 of the host apparatus 305 reads out the second image data 650 from the magnetic disk apparatus 304 and transfers the second image data 650 to the first memory circuit 302 of the host apparatus 305. Further, the system control section 301 stores the FE (metadata file) 621 in the first memory circuit 302.

Step S103: The system control section 301 instructs the drive apparatus 310 to record the second image data 650.

Step S104: The drive control section 311 of the drive apparatus 310 transfers the second image data 650 from the first memory circuit 302 to the second memory circuit 312 of the drive apparatus 310.

Step S105: The drive control section 311 records the second image data 650 on unrecorded contiguous areas of the write-once recording medium 100, while making reference to the session management information 200 and/or the space bitmap management information 220.

Step S106: The system control section 301 instructs the drive apparatus 310 to pseudo-overwrite the FE (metadata file) 621 stored in the first memory circuit 302 on the FE (metadata file) 441.

Step S107: The drive apparatus 310 records, as the FE (metadata file) 640, the second FE (metadata file) 621 transferred from the memory circuit 302 in the inner spare area 106 of the write-once recording medium 100. Further, the drive apparatus 310 updates replacement information included in the disk management information recorded in the first disk management information area 104 and maps the first FE (metadata file) 441 to the FE (metadata file) 640. The FE (metadata file) 640 is address information indicating a recording location of the second metadata file 620. In other words, new replacement management information 1010 is generated. The new replacement management information 1010 includes original location information 1012 indicating a location of the first FE (metadata file) 441 and a replacement location information 1013 indicating a location of the FE (metadata file) 640. The new replacement management information 1010 is added to the replacement management information list 1000. Further, in a similar manner, the pseudo-overwrite recording is performed on the first FE (metadata mirror file) 451, and the first FE (metadata mirror file) 451 is mapped to the FE (metadata mirror file) 641. Due to the process mentioned above, the partition map (type 2) 602 which have made reference to the first FE (metadata file) 441 makes reference to the second FE (metadata file) 621 (see FIG. 15).

Step S108: The disk management information is updated to reflect the result of the recording process. For example, the last recorded address information 1107 is updated. The session management information 200 and the space bitmap management information 220 are updated to the latest status in response to the recording of the second image data 650. Concurrently, the replacement management information list 1000 may be updated.

After the disk management information is updated, the process is completed.

2-4. Reproduction Procedure

FIG. 22 shows a reproduction procedure according to Embodiment 2 of the present invention. The reproduction procedure is realized by the recording/reproduction apparatus 300B.

Hereinafter, the reproduction procedure according to Embodiment 2 of the present invention will be described step by step with reference to FIGS. 12, 18 and 22.

When the steps which will be described below are performed, the recording/reproduction apparatus 300B reproduces the data file (File-a) 460 from the write-once recording medium 100 having the data structure which has been described with reference to FIG. 18.

Step S201: The system control section 301 of the host apparatus 305 instructs the drive apparatus 310 to reproduces the AVDP 600 which is recorded at a predetermined location (e.g., logical address “256”) of the write-once recording medium 100.

Step S202: The system control section 301 obtains location information of the main volume structure 410 which is included in the AVDP 600. The system control section 301 instructs the drive apparatus 310 to reproduce the main volume structure 410. Further, the system control section 301 obtains location information (logical address) of the first FE (metadata file) 441 which is included in the main volume structure 410.

Step S203: The system control section 301 reproduces the file structure. For reproducing the file structure, the system control section 301 instructs the drive apparatus 310, based on the location information (logical address) of the obtained first FE (metadata file) 441, to perform the reproduction.

Step S204: The drive apparatus 310 refers to the replacement management information list 1000 and retrieves the replacement management information 1010 held as the original location information 1012 corresponding to the location information (logical address) of the first FE (metadata file) 441. If the corresponding replacement management information 1010 is found, the drive apparatus 310 obtains the replacement location information 1013 included in the replacement management information 1010. As a result, the location information of the FE (metadata file) 640 is obtained. The drive apparatus 310 reproduces the FE (metadata file) 640 and returns it to the system control section 301.

The FE (metadata file) 640 includes the information which is same as that in the second FE (metadata file) 621. Accordingly, the system control section 301 obtains the location information of the second metadata file 620 from the information of the obtained FE (metadata file) 640. Thus, it is possible to access the metadata file 620 included in the latest file management information.

Step S205: The drive control section 311 of the drive apparatus 310 controls the recording/reproduction section 314 such that the recording/reproduction section 314 reproduces the data file (File-a) 460. Files are reproduced in accordance with a normal reproduction procedure of the UDF specification.

After the data file (File-a) 460 is reproduced, the process is completed. In the description of the reproduction procedure according to Embodiment 2 of the present invention, the handling of the metadata mirror file has been omitted. However, the metadata mirror file can be recorded/reproduced in a similar manner as performed on the metadata file, as necessary.

As described in the reproduction procedure according to Embodiment 2 of the present invention, it is possible to pseudo-overwrite information in a predetermined area by using a replacement mechanism which is made up by replacement information and a replacement area. Thus, on the logical space, this file structure is the same as the read-only file structure. Therefore, it is possible to reproduce data recorded in a write-once recording medium, even in the system which only can perform a reproduction operation for the read-only recording medium or the rewritable recording medium.

Further, it is possible to perform an efficient incremental recording of data using the image data and it is also possible to access the latest file structure at a high speed without performing the search for the lead-in (border-in) area, the lead-out (border-out) area and the like.

Furthermore, since only the minimum amount of data is updated by the pseudo-overwriting, it is possible to alleviate the load of the replacement process, and it is also possible to suppress the consumption of spare area.

### 3. Embodiment 3

Hereinafter, Embodiment 3 according to the present invention will be described with reference to the accompanying drawings.

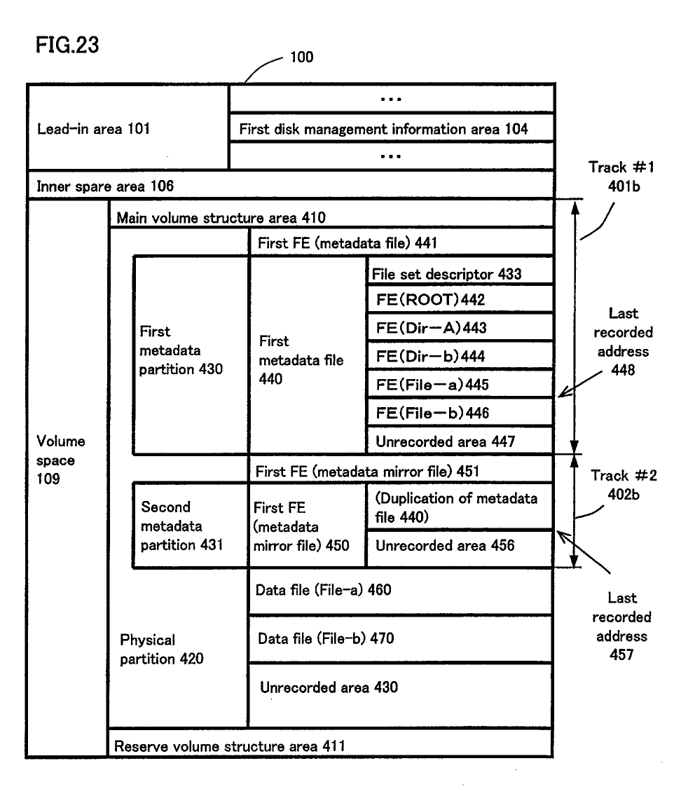

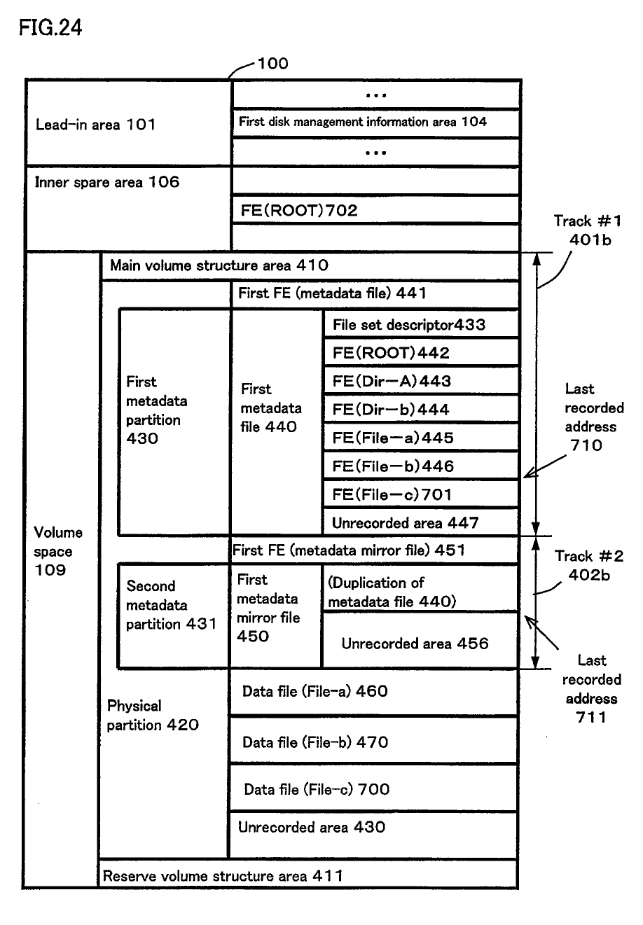

FIGS. 23 and 24 show an example of a data structure of the write-once recording medium 100 according to Embodiment 3 of the present invention. The data structure of the write-once recording medium 100 according to Embodiment 3 of the present invention is similar to the data structure which has been described in “2-1 Write-once recording medium” according to Embodiment 2 of the present invention except that in the write-once recording medium 100 according to Embodiment 3 of the present invention, data file (File-c) 700, FE (File-c) 701 and FE (ROOT) 702 are recorded; and a recording location of data in the data structure of the write-once recording medium 100 according to Embodiment 3 of the present invention is different from that in the data structure which has been described in “2-1 Write-once recording medium” according to Embodiment 2 of the present invention. Accordingly, in FIGS. 23 and 24, the same reference numbers are denoted to the areas which have been described with reference to FIGS. 1, 12 and 18, and the description thereof will be omitted.

FIGS. 23 and 24 show examples of track structures which have been omitted in the description of FIGS. 12 and 18.

In FIGS. 23 and 24, a plurality of tracks is allocated to the volume space 109. Track #1 401b is allocated as a track for recording the main volume structure 410 and the first metadata file 440 at the time when a format process is performed on the information recording medium 100.

Track #2 402b is allocated as a track for recording the second metadata mirror file 450 at the time when a format process is performed on the information recording medium 100.

Further, the reference relationship between data included in the volume structure and the file structure, respectively, of the write-once recording medium is similar to the reference relationship which has been described with reference to FIGS. 13 and 15.

Furthermore, the recording/reproduction 300 according to Embodiment 3 of the present invention has a structure similar to that described in “2-2. Recording/reproduction apparatus” according to Embodiment 2 of the present invention. Thus, the description thereof will be omitted.

Still further, a pseudo-overwrite recording and empty area management according to Embodiment 3 of the present invention can be realized by a method similar to that described in “1-2. Pseudo-overwrite recording” and “1-6. Empty area management” according to Embodiment 1 of the present invention. Thus, the description thereof will be omitted.

3-1. Recording Procedure

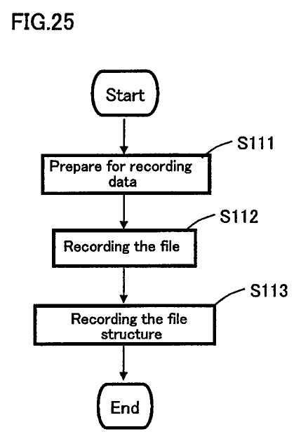

FIG. 25 shows a recording procedure according to Embodiment 3 of the present invention. The recording procedure is realized by the recording/reproduction apparatus 300.

Hereinafter, the recording procedure according to Embodiment 3 of the present invention will be described step by step with reference to FIGS. 20, 23, 24 and 25.

When the steps which will be described below are performed, the recording/reproduction apparatus 300 records the data file (File-c), which is present in the magnetic disk apparatus 304, immediately below the ROOT directory of the write-once recording medium 100 having the data structure shown in FIG. 23; and creates the write-once recording medium 100 having the data structure shown in FIG. 24.

Step S111: When the recording of the data file (File-c) starts, the system control section 301 of the host apparatus 305 reads out the data file (File-c) from the magnetic disk apparatus 304 and transfers the data file (File-c) to the memory circuit 302.

Further, the system control section 301 generates and updates information of a file structure, which is required for addition of the data file (File-c) and holds the information in the first memory circuit 302. Specifically, the system control section 301 generates the FE (File-c) 701 and updates the FE (ROOT) 702. The ROOT directory file is included in the FF (ROOT) 702.

Step S112: The system control section 301 instructs the drive apparatus 310 to record the data file (File-c). Concurrently, the drive apparatus 310 records the data file (File-c) 700 in the unrecorded area 430 while making reference to the session management information 200 and/or the bitmap space management information 220, as necessary.

Step S113: The system control section 301 instructs the drive apparatus 310 to record the FE (File-c) 701 held in the first memory circuit 302. Concurrently, the FE (File-c) 701 is recorded in the unrecorded area 445 of the first metadata partition 430 (i.e., first metadata file 440). Also, the system control section 301 instructs the drive apparatus 310 to overwrite the FE (ROOT) 702 on the FE (ROOT) 442. The instruction-received drive apparatus 310 records the FE (ROOT) 702, which is transferred from the memory circuit 302, in the inner spare area 106. Further, the drive apparatus 310 updates the replacement information included in the first disk management information 104 and maps the FE (ROOT) 442 to the FE (ROOT) 702.

After the file structure is recorded, a necessary process (management of unrecorded area and the like) is performed, and the process is completed.

In the description of the recording procedure according to Embodiment 3 of the present invention, the description regarding the handling of the first metadata mirror file 450 has been omitted. However, the metadata mirror file can be recorded/reproduced in a similar manner as performed on the metadata file, as necessary.

The entire area of the first metadata partition 430/first metadata file 440 is managed as “allocated and recorded” by an allocation descriptor included in the first FE (metadata file) 441. Accordingly, even if a process of new incremental recording of the FE (File-c) 701 is performed, there is no need for updating the information which holds the first FE (metadata file) 441, which is advantageous in structuring a system. Concurrently, the management of unrecorded area of the first metadata partition 430/first metadata file 440 can be realized by the track management information and/or the bitmap space management information.

3-2. Reproduction Procedure

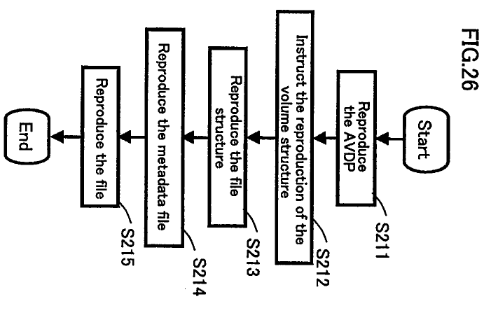

FIG. 26 shows a reproduction procedure according to Embodiment 3 of the present invention. The reproduction procedure is realized by the recording/reproduction apparatus 300.

Hereinafter, the reproduction procedure according to Embodiment 3 of the present invention will be described step by step with reference to FIGS. 23, 24 and 26.

When the steps which will be described below are performed, the recording/reproduction apparatus 300 reproduces the data file (File-c) 700 from the write-once recording medium 100 having the data structure which has been described with reference to FIG. 24.

Step S211: The system control section 301 of the host apparatus 305 instructs the drive apparatus 310 to reproduces the AVDP 600 which is recorded at a predetermined location (e.g., logical address “256”) of the write-once recording medium 100.

Step S212: The system control section 301 obtains location information of the main volume structure 410 which is included in the AVDP 600. The system control section 301 instructs the drive apparatus 310 to reproduce the main volume structure 410. Further, the system control section 301 obtains location information of the first FE (metadata file) 441 which is included in the main volume structure 410. Furthermore, the system control section 301 obtains location information of the file set descriptor 433 which is included in the main volume structure 410.

Step S213: The system control section 301 reproduces the file structure. For reproducing the file structure, the system control section 301 instructs to the drive apparatus 310, based on the location information (logical address) of the obtained first FE (metadata file) 441 and the file set descriptor 433, to perform the reproduction.

As shown in FIG. 15, it is possible to obtain location information (logical address) of the FE (ROOT) 442 from the reproduced file set descriptor 433. The system control section 301 instructs the drive apparatus 310, based on the location information (logical address) of the obtained FE (ROOT) 442, to reproduce the FE (ROOT) 442.

Step S214: The instruction-received drive apparatus 310 makes reference to the replacement information, reproduces the FE (ROOT) 702, which is mapped to the location information (logical address) of the FE (ROOT) 442 and returns the reproduced FE (ROOT) 702 to the system control section 301.

As described above, the FE (ROOT) 702 includes the latest ROOT directory file and accordingly, it has the location information of the FE (File-c) 701.

Step S215: The drive apparatus 310 reproduces the data file (File-c) 700. In other words, the location information of the data file (File-c) 700, which has been obtained from the FE (File-c) 701 referenced to and then, the drive apparatus 310 is instructed to perform the reproduction.

After the data file (File-c) 700 is reproduced, the process is completed.

In the description of the recording procedure according to Embodiment 3 of the present invention, the description regarding the handling of the metadata mirror file has been omitted. However, the metadata mirror file can be recorded/reproduced in a similar manner as performed on the metadata file, as necessary.

According to the recording procedure and the reproduction procedure according to Embodiment 3 of the present invention, even when a sequential recording of data file is performed, it is possible to efficiently perform an incremental recording of the file.

Since file structures are all record in particular tracks, it is possible to access to a data file at a high speed.

Depending on the size of the empty area of the first metadata file 440, a new track may be allocated to the first metadata partition 430. For example, if there is no empty area of the first metadata file 440, a new track is allocated to the first metadata partition 430 so as to expand the first metadata partition 430. When the first metadata partition 430 is expanded, the first FE (metadata file) 441 may be pseudo-overwritten since it is necessary to update the first FE (metadata file) 441.

In Embodiment 3 of the present invention, the metadata is allocated to a single track. However, the metadata may be allocated to a plurality of tracks. When the metadata is allocated to the plurality of tracks, each of the plurality of tracks is allocated for each type (e.g., FE and directory file) of data of the file structure. Further, it is possible to allocate the tracks in view of the directory tree. For example, a directory tree for recording data for a particular application (e.g., TV program recording) is first determined and then, tracks are allocated for files and directories below the directory. As a result, at the time of utilization in accordance with the particular application, it is possible to perform an efficient data access.

### 4. Embodiment 4

Hereinafter, Embodiment 4 according to the present invention will be described with the accompanying drawings. In Embodiment 4 of the present invention, the data file (File-c) is recorded on the write-once recording medium 100 which has been described with reference to FIG. 23, by using a recording procedure which is different from the recording procedure described in Embodiment 3 of the present invention.

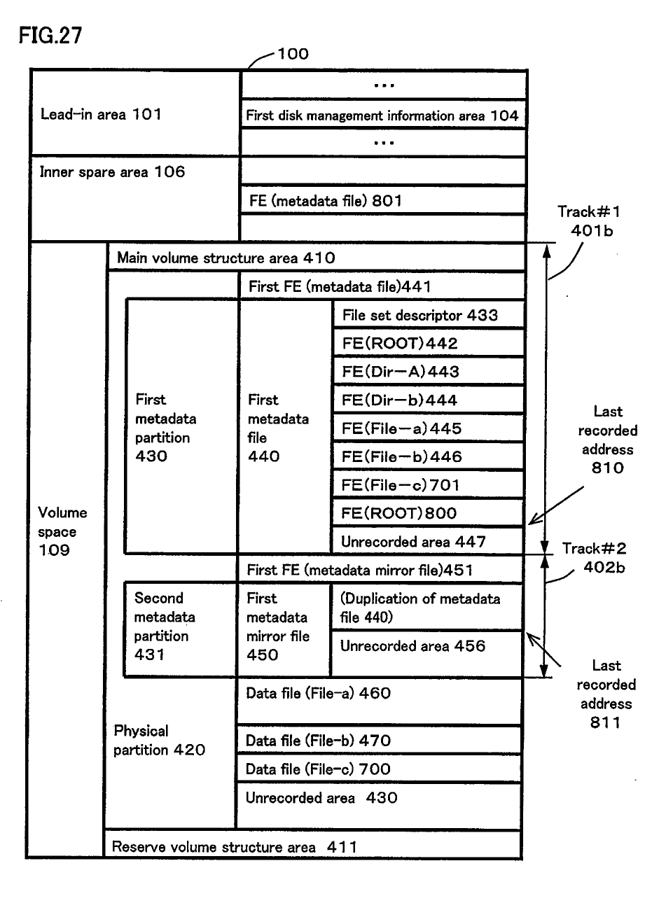

FIG. 27 shows a data structure of the write-once recording medium 100 according to Embodiment 4 of the present invention. The data structure shown in FIG. 27 is created by recording the data file (File-c) on the write-once recording medium 100 described with reference to FIG. 23, by using the recording procedure which will be described in Embodiment 4 of the present invention.

The difference between the data structure shown in FIG. 27 and the data structure shown in FIG. 24 is that in the data structure shown in FIG. 24, the target for the pseudo-overwrite recording when the data file (File-c) is recorded is a portion of data which makes up the first metadata file 440 (specifically, the FE (ROOT) 442 portion), and on the other hand, in the data structure shown in FIG. 27, the first FE (metadata file) 441 is targeted for the pseudo-overwrite recording.

In Embodiment 4 of the present invention, the reference relationship between data included in the volume structure and the file structure, respectively, of the write-once recording medium is similar to the reference relationship which has been described with reference to FIGS. 13 and 15. Thus, the description thereof will be omitted.

The recording/reproduction according to Embodiment 4 of the present invention has a structure similar to that described in “2-2. Recording/reproduction apparatus” according to Embodiment 2 of the present invention. Thus, the description thereof will be omitted.

Further, a pseudo-overwrite recording and empty area management according to Embodiment 4 of the present invention can be realized by a method similar to that described in “1-2. Pseudo-overwrite recording” and “1-6. Empty area management” according to Embodiment 1 of the present invention. Thus, the description thereof will be omitted.

4-1. Recording Procedure

In the recording procedure described with reference to FIG. 25, the information of the ROOT directory is updated by performing a pseudo-overwrite recording on the FE (ROOT) 442 in step S113. However, in a recording procedure according to Embodiment 4 of the present invention, the information of the ROOT directory is updated by recording FE (ROOT) 800, which is information after the FE (ROOT) 442 is updated, in the unrecorded area 447 of the first metadata partition 430. The first FE (metadata file) 441 is updated such that the FE (ROOT) 800 is made reference to, instead of the FE (ROOT) 442.

This updating can be performed by changing the allocation descriptor included in the FE. Specifically, it is assumed that a relative logical address in the first metadata file 440 (i.e., within the partition 430) of the FE (ROOT) 442 is “2”. This relative logical address is managed by the allocation descriptor of the first FE (metadata file) 411. Thus, this allocation descriptor is changed and the relative logical address value of the FE (ROOT) 800 is set as “2”. Further, regarding the portion in which the information among the first metadata file 440 is not updated, values of other allocation descriptors adjusted such that the logical address does not change.

The new FE (metadata file) 801 including these allocation descriptors is pseudo-overwritten on the FE (ROOT) 442.

A process of generating the FE (metadata file) 801 is performed by the first memory circuit 302 and the like under the instruction of the system control section 301.

4-2. Reproduction procedure

A reproduction procedure according to Embodiment 4 of the present invention is substantially the same as the reproduction procedure according to Embodiment 3 of the present invention, which has been described with reference to FIG. 26. However, there is a difference in that data which is pseudo-overwritten in the reproduction procedure according to Embodiment 3 of the present invention is the FE (ROOT) 702, and on the other hand, data which is pseudo-overwritten in the reproduction procedure according to Embodiment 4 of the present invention is the FE (metadata file) 801. In the reproduction procedure according to Embodiment 4 of the present invention, if the reproduction of the first FE (metadata file) 441 is instructed, the FE (metadata file) 801 is reproduced.

In the description made above, the handling of the metadata mirror file has been omitted. However, it can be recorded/reproduced in a similar manner as performed on the metadata file.

In Embodiment 4 of the present invention, even when a sequential recording of a data file is performed, it is possible to efficiently perform an incremental recording of the file. Particularly, in the present embodiment, the unit of pseudo-overwrite recording is always the first FE (metadata file) 441. Thus, the present embodiment is, in particular, excellent in data efficiency.

All data included in the first metadata file 440 is present in the track #1 401b and is not arranged in the inner spare area 106. Thus, it is possible to continuously reproduce the first metadata file 440 and therefore, it is possible to access to a data file at a higher speed.

### 5. Embodiment 5

In Embodiment 5 of the present invention, a description will be made, in which a procedure of recording data on the write-once recording medium 100 shown in FIG. 23 is performed by using a recording procedure which is different from the recording procedure described in Embodiment 3 of the present invention.

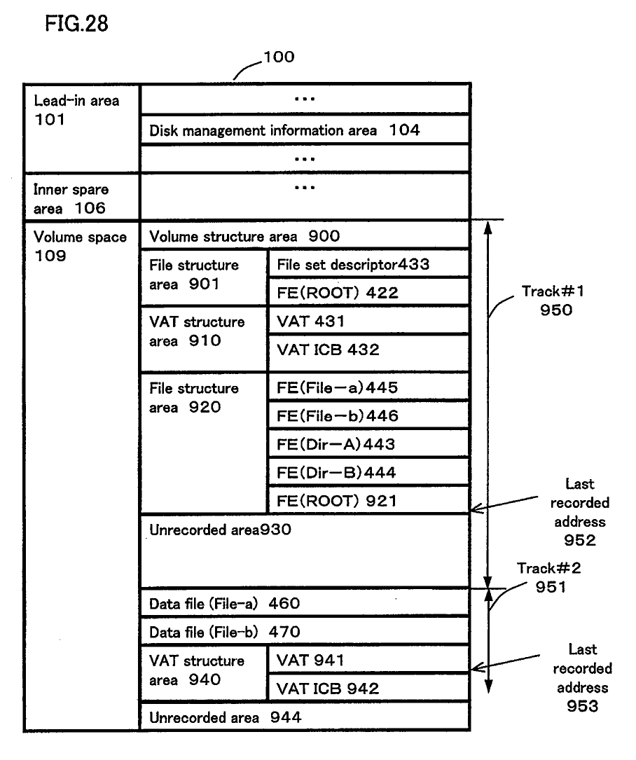

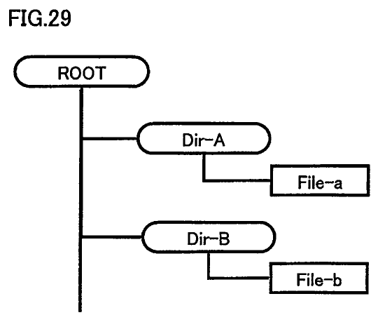

FIG. 28 shows a data structure of the write-once recording medium 100 where the file and directory structure shown in FIG. 29 is recorded by using the VAT method. Track #1 950 and track #2 951 are allocated to the write-once recording medium 100 in order to record a file structure and a VAT structure.

The description will be made regarding the process of converting the data structure of the write-once recording medium 100 shown in FIG. 28 to a volume structure/file structure which uses a metadata file. This conversion process is performed for the purpose of improving the compatibility with the write-once recording medium 100 under the UDF specification in which a plurality of recording formats exists.

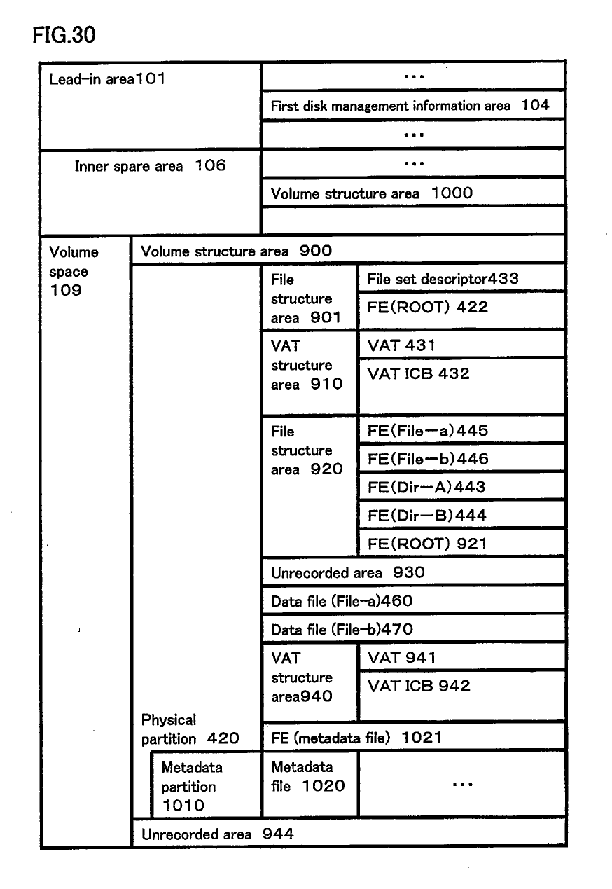

FIG. 30 shows the write-once recording medium 100 created by changing the data structure by the conversion process according to Embodiment 5 of the present invention.

The volume structure is converted by the conversion process. The volume structure area 900 has a form which is specific to the VAT method. Thus, the volume structure area 900 generates data of a volume structure area 1000 with which the metadata partition can be recorded and performs a pseudo-overwrite recording on the data. As a result, the conversion of the volume structure is performed.

FE (metadata file) 1021 and metadata file 1020 are generated in order to perform a conversion on the file structure. In this case, an allocation descriptor of the FE (metadata file) 1021 is generated such that an address value of a virtual address space in the VAT method and an address value of the metadata partition 1010 match each other. For example, the virtual address space in the VAT method of the file set descriptor 433 is “0”. Accordingly, the FE (metadata file 1021 is generated such that an address within the metadata partition 1010 of the converted file set descriptor 433 is also “0”. The virtual address the file set descriptor 433 makes reference to is “1”. Thus, the FE (ROOT) is arranged at the address “1” within the metadata partition 1010 such that the value “1” does not change after the conversion.

According to the conversion process of Embodiment 5 of the present invention, it is possible to convert the unmodified file structure recorded in the VAT method to the volume structure/file structure which uses the metadata file. Therefore, it is possible to perform a high speed conversion and efficiently utilize the recording area.

Embodiments 1 to 5 have been described with reference to the accompanying drawings. The write-once recording medium 100 according to Embodiments 1 to 5 of the present invention has one layer of recording surface. However, the number of the recording surfaces included in the write-once recording medium 100 is not limited to the one layer. The number of the recording surfaces included in the write-once recording medium 100 may be a plurality of layers.

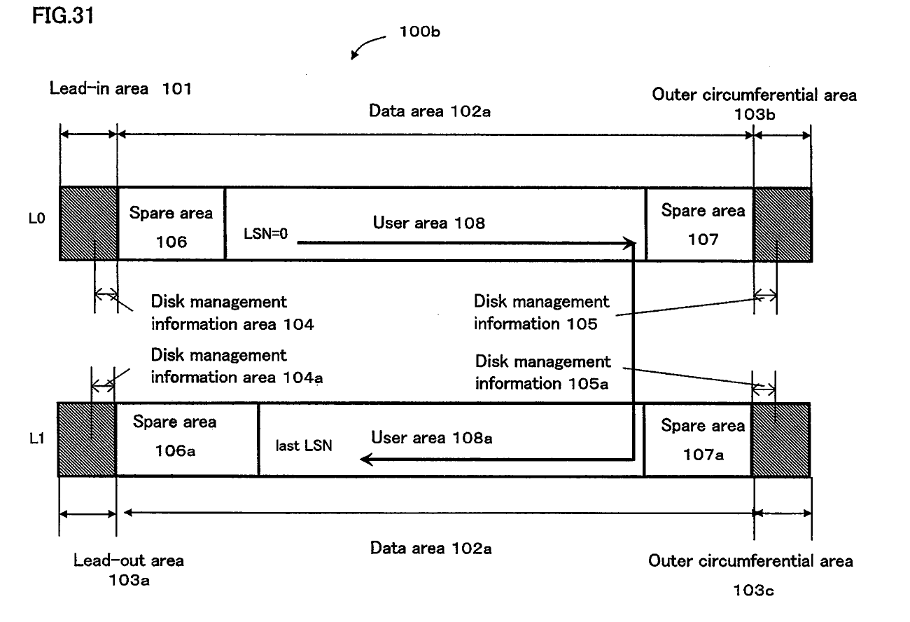

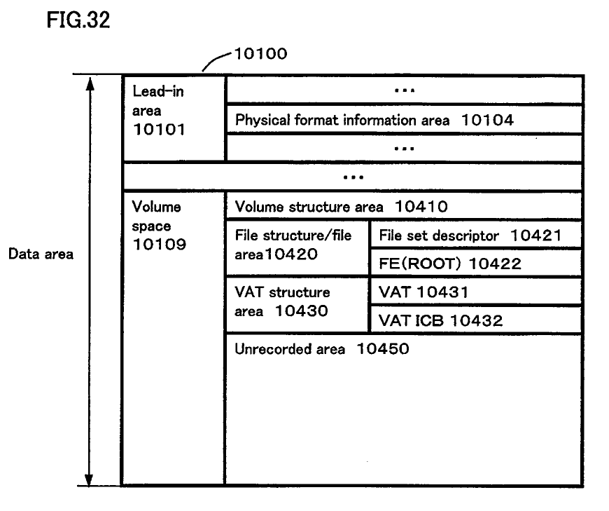

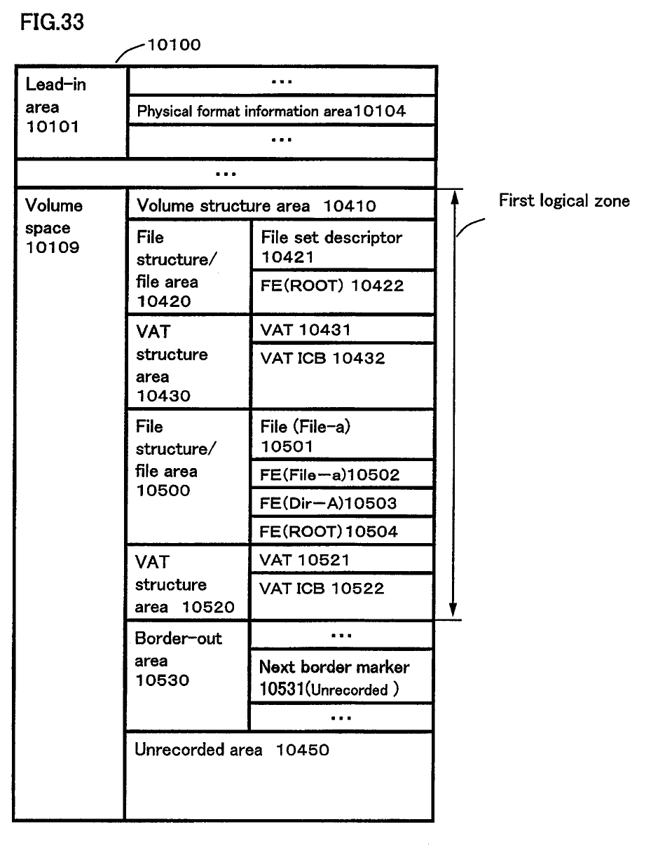

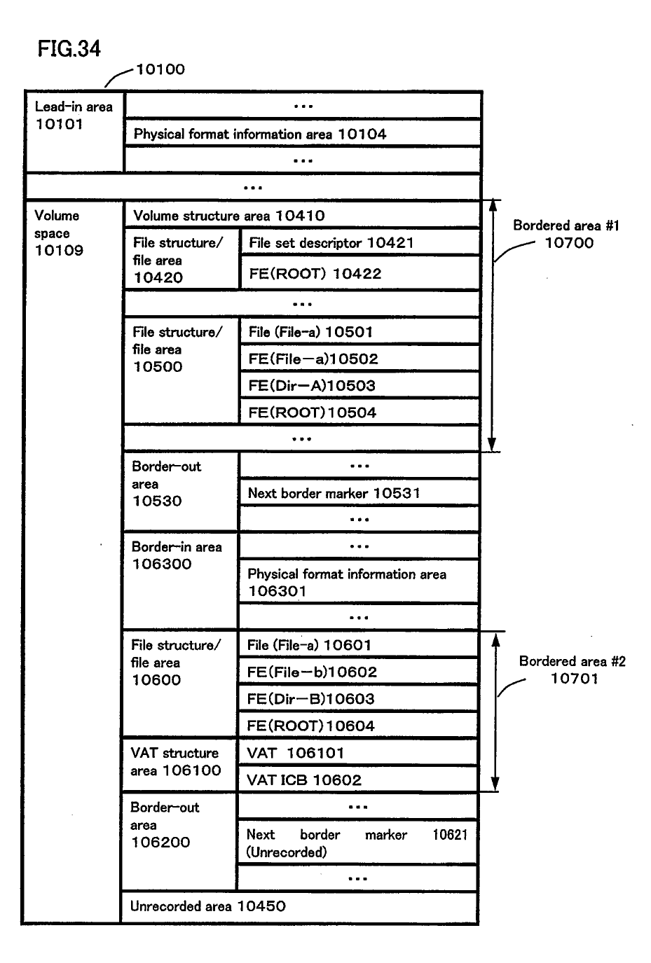

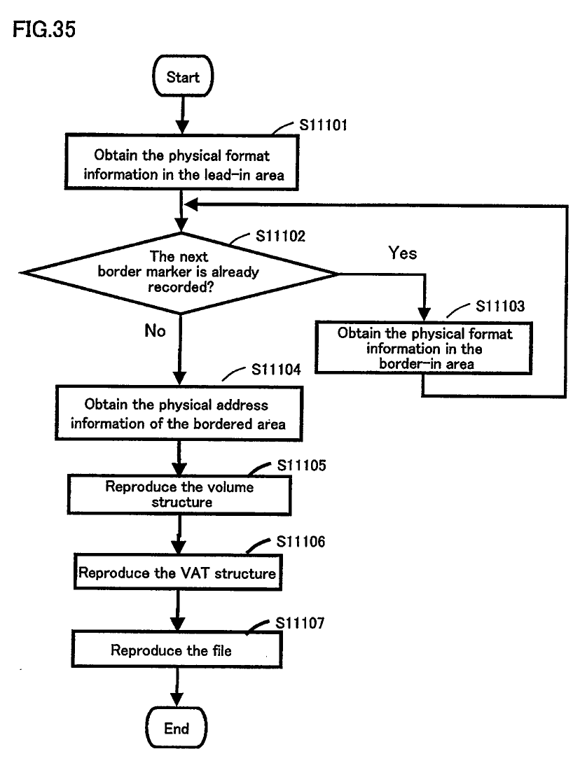

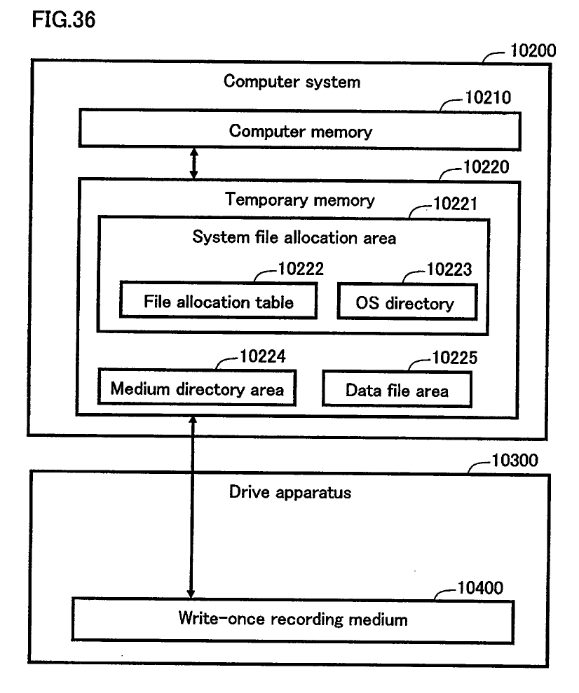

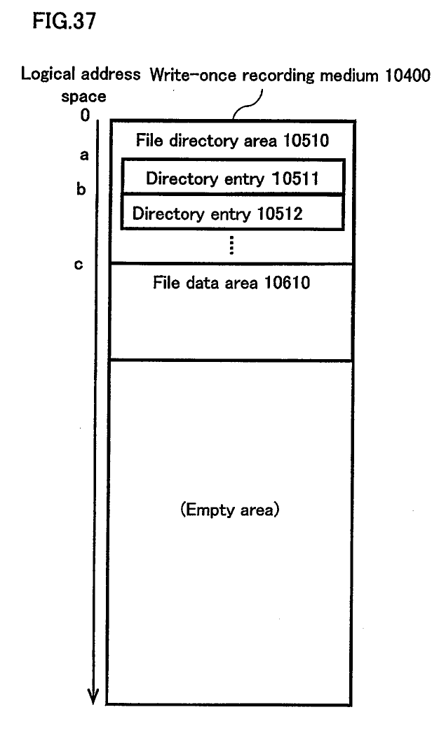

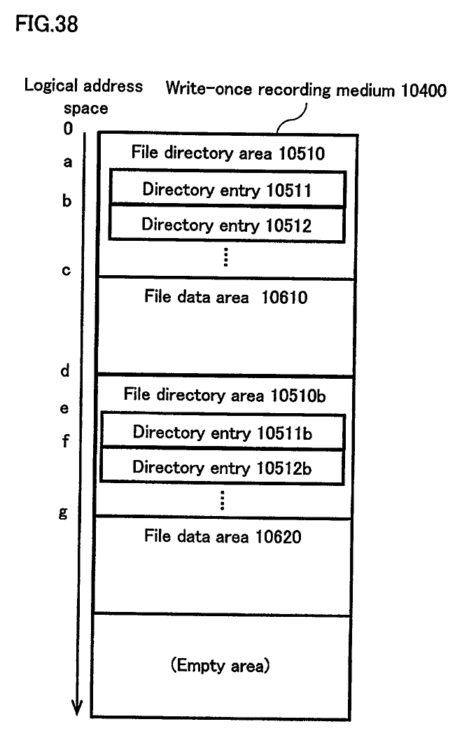

FIG. 31 shows a data structure of a write-once recording medium 100b which has two layers of recording surfaces. The write-once recording medium 100b has a first layer L0 and a second layer L1.

Each of the first layer L0 and the second layer L1 of the write-once recording medium 100b has substantially the same structure as that of the write-once recording medium 100. On the most inner side of the first layer L0 of the write-once recording medium 100b, a lead-in area 101 is allocated. On the most inner side of the second layer L1 of the write-once recording medium 100b, a lead-out area 103a is allocated. Further, on the most outer side of the first layer L0 of the write-once recording medium 100b, an outer circumferential area 103b is allocated, and on the most outer side of the second layer L1 of the write-once recording medium 100b, an outer circumferential area 103c is allocated.

The lead-in area 101 includes a disk management information area 104. The outer circumferential area 103b includes a disk management information area 105. Further, the lead-out area 103a includes a disk management information area 104a, and the outer circumferential area 103c includes a disk management information area 105a.

In the first layer L0 of the write-once recording medium 100b, a spare area 106 and a spare area 107 are allocated, and in the second layer L1 of the write-once recording medium 100b, a spare area 106a and a spare area 107a are allocated. The capacity of these spare areas can be changed depending on a recording medium. Further, in the first layer L0 of the write-once recording medium 100b, a user area 108 is allocated, and in the second layer L1 of the write-once recording medium 100b, a user area 108a is allocated. These user areas are regarded as one volume space which has logically continuous address. Therefore, logically, it is possible to handle a write-once recording medium having a plurality of recording surfaces in a similar manner to a write-once recording medium having one layer of recording surface.

### INDUSTRIAL APPLICABILITY

The present invention includes a host apparatus and drive apparatus. The present invention can generate correlation information for correlating first information and second information by the drive apparatus and record the second information and the correlation information on a write-once recording medium. Therefore, it is possible to record the correlation information on the write-once recording medium without having the correlation information being generated by the host apparatus. As a result, on the logical space, this file structure is the same as the read-only and rewritable file structure. Thus, it is possible to record data on the write-once recording medium without using a file system which is specific to file incremental recording, as used in the multiborder system.

The present invention includes a host apparatus and a drive apparatus and can reproduce second information from the write-once recording medium based on correlation information for correlating first information and the second information by the drive apparatus. Therefore, it is possible to reproduce the second information from the write-once recording medium by the drive apparatus without instructing to reproduce the second information by the host apparatus. As a result, on the logical space, this file structure is the same as the read-only file structure. Thus, it is possible to reproduce data in the write-once recording medium even in a system which only can perform a reproduction operation for read-only recording medium or rewritable recording medium.

1. A recording apparatus for recording second information on a write-once recording medium having first information recorded thereon, the recording apparatus comprising:
a host apparatus; and
a drive apparatus, wherein
the host apparatus includes
a storage section for storing the second information; and
an instruction section for instructing the drive apparatus to record the stored second information on the write-once recording medium,
the drive apparatus includes
a generation section for generating correlation information for correlating the first information and the second information;
a head section for recording the second information on the write-once recording medium; and
a control section for controlling the head section to record the second information and the correlation information on the write-once recording medium.

2. A recording apparatus according to claim 1, wherein the first information includes file management information,
the second information includes update information generated by updating the file management information,
the generation section generates first correlation information for correlating the file management information and the update information and
the control section controls the head section to record the update information and the first correlation information on the write-once recording medium.

3. A recording apparatus according to claim 2, wherein the write-once recording medium includes at least one first track and at least one second track which is different from the at least one first track,
the at least one first track is an area for recording the file management information and
the at least one second track is an area for recording user data.

4. A recording apparatus according to claim 2, wherein the host apparatus further includes
an obtaining section for obtaining last location information indicating a last location of information recorded on the write-once recording medium; and
a determination section for determining a recording location of data based on the last location information, and
the control section controls the head section such that the head section records the data at the recording location.

5. A recording apparatus according to claim 1, wherein the first information further includes management information, the management information managing the file management information,
the second information includes first update information generated by updating the management information and
the generation section generates second correlation information for correlating the management in-formation and the first update information,
the control section controls the head section to record the first update information and the second correlation information on the write-once recording medium.

6. A recording apparatus according to claim 5, wherein the write-once recording medium includes at least one first track and at least one second track which is different from the at least one first track,
the at least one first track is an area for recording the file management information and
the at least one second track is an area for recording user data.

7. A recording apparatus according to claim 5, wherein the host apparatus further includes
an obtaining section for obtaining last location information indicating a last location of information recorded on the write-once recording medium; and
a determination section for determining a recording location of data based on the last location information, and
the control section controls the head section such that the head section records the data at the recording location.

8. A host apparatus included in a recording apparatus for recording second information on a write-once recording medium having first information recorded thereon, the recording apparatus further including a drive apparatus for recording correlation information for correlating the first information and the second information and the second information on the write-once recording medium, the host apparatus comprising:
a storage section for storing the second information; and
an instruction section for instructing the drive apparatus to record the stored second information on the write-once recording medium.

9. A host apparatus according to claim 8, wherein the first information includes file management information and
the second information includes update information generated by updating the file management information.

10. A host apparatus according to claim 9, wherein the write-once recording medium includes at least one first track and at least one second track which is different from the at least one first track,
the at least one first track is an area for recording the file management information and
the at least one second track is an area for recording user data.

11. A host apparatus according to claim 8, further comprising:
an obtaining section for obtaining last location information indicating a last location of information recorded on the write-once recording medium; and
a determination section for determining a recording location of data based on the last location information, and
the drive apparatus records the data at the recording location.

12. A host apparatus according to claim 8, wherein the first information further includes management information, the management information managing the file management information, and
the second information includes first update information generated by updating the management information.

13. A drive apparatus included in a recording apparatus for recording second information on a write-once recording medium having first information recorded thereon, the recording apparatus further including a host apparatus for instructing the drive apparatus to record the second information on the write-once recording medium,
the drive apparatus comprising:
a generation section for generating correlation information for correlating the first information and the second information;
a head section for recording the second information on the write-once recording medium; and
a control section for controlling the head section to record the second information and the correlation information on the write-once recording medium.

14. A drive apparatus according to claim 13, wherein the first information includes file management information,
the second information includes update information generated by updating the file management information,
the generation section generates first correlation information for correlating the file management information and the update information and
the control section controls the head section to record the update information and the first correlation information on the write-once recording medium.

15. A drive apparatus according to claim 14, wherein the write-once recording medium includes at least one first track and at least one second track which is different from the at least one first track,
the at least one first track is an area for recording the file management information and
the at least one second track is an area for recording user data.

16. A drive apparatus according to claim 13, wherein the host apparatus determines a recording location of data based on last location information indicating a last location of information recorded on the write-once recording medium, and
the control section controls the head section such that the head section records the data at the recording location.

17. A drive apparatus according to claim 14, wherein the first information further includes management information, the management information managing the file management information,
the second information includes first update information generated by updating the management information,
the generation section generates second correlation information for correlating the management in-formation and the first update information,
the control section controls the head section to record the first update information and the second correlation information on the write-once recording medium.

18. A recording method for recording second information on a write-once recording medium having first information recorded thereon, the recording method comprising:
an instruction step of instructing to record the second information on the write-once recording medium;
a generation step of generating correlation information for correlating the first information and the second information; and
a recording step of recording the second information and the correlation information on the write-once recording medium.

19. An instruction method executed by a host apparatus included in a recording apparatus for recording second information on a write-once recording medium having first information recorded thereon, the recording apparatus recording correlation information for correlating the first information and the second information and the second information on the write-once recording medium,
the instruction method comprising:
an instruction step of instructing to record the second information on the write-once recording medium.

20. A method executed by a drive apparatus included in a recording apparatus for recording second information on a write-once recording medium having first information recorded thereon, the recording apparatus instructing the drive apparatus to record the second information on the write-once recording medium, the method comprising:
a generation step of generating correlation information for correlating the first information and the second information; and
a recording step of recording the second information and the correlation information on the write-once recording medium.

21. A program for executing a recording procedure by a recording apparatus for recording second information on a write-once recording medium having first information recorded thereon, the recording procedure including
an instruction step of instructing to record the second information on the write-once recording medium;
a generation step of generating correlation information for correlating the first information and the second information; and
a recording step of recording the second information and the correlation information on the write-once recording medium.

22. A program for executing an instruction procedure by a host apparatus included in a recording apparatus for recording second information on a write-once recording medium having first information recorded thereon, the recording apparatus recording correlation information for correlating the first information and the second information and the second information on the write-once recording medium,
the instruction procedure including
an instruction step of instructing to record the second information on the write-once recording medium.

23. A program for executing a recording procedure by a drive apparatus included in a recording apparatus for recording second information on a write-once recording medium having first information recorded thereon, the recording apparatus instructing the drive apparatus to record the second information on the write-once recording medium, the recording procedure including
a generation step of generating correlation information for correlating the first information and the second information; and
a recording step of recording the second information and the correlation information on the write-once recording medium.

24. An integrated circuit included in a recording apparatus for recording second information on a write-once recording medium having first information recorded thereon, wherein
the recording apparatus further include a drive apparatus for recording correlation information for correlating the first information and the second information and the second information on the write-once recording medium and
the integrated circuit instructs the drive apparatus to record the second information on the write-once recording medium.

25. An integrated circuit included in a recording apparatus for recording second information on a write-once recording medium having first information recorded thereon, the recording apparatus further including an apparatus for instructing the drive apparatus to record the second information on the write-once recording medium, the integrated circuit comprising:
a generation section for generating correlation information for correlating the first information and the second information; and
a control section for recording the second information and the correlation information on the write-once recording medium.

26. A reproduction apparatus for reproducing second information from a write-once recording medium having first information and the second information recorded thereon, correlation information for correlating the first information and the second information being further recorded on the write-once recording medium, the reproduction apparatus comprising:
a host apparatus; and
a drive apparatus, wherein
the host apparatus includes
an instruction section for instructing the drive apparatus to reproduce the second information from the write-once recording medium,
the drive apparatus includes
a head section for reproducing the second information from the write-once recording medium; and
a control section for controlling the head section to reproduce the second information from the write-once recording information based on the correlation information.

27. A reproduction apparatus according to claim 26, wherein the first information includes file management information,
the second information includes update information generated by updating the file management information,
first correlation information for correlating the file management information and the update information is recorded on the write-once recording medium and
the control section controls the head section to reproduce the update information from the write-once recording medium based on the first correlation information.

28. A reproduction apparatus according to claim 26, wherein the write-once recording medium includes at least one first track and at least one second track which is different from the at least one first track,
the at least one first track is an area for recording the file management information and
the at least one second track is an area for recording user data.

29. A reproduction apparatus according to claim 27, wherein the first information further includes management information, the management information managing the file management information,
the second information includes first update information generated by updating the management information,
second correlation information for correlating the management information and the first update information is recorded on the write-once recording medium and
the control section controls the head section to reproduce the first update information from the write-once recording medium based on the second correlation information.

30. A host apparatus included in a reproduction apparatus for reproducing second information from a write-once recording medium having first information and the second information recorded thereon, correlation information for correlating the first information and the second information being further recorded on the write-once recording medium, the reproduction apparatus further including a drive apparatus for reproducing the second information from the write-once recording medium based on the correlation information, the host apparatus comprising:
an instruction section for instructing the drive apparatus to reproduce the second information from the write-once recording medium.

31. A host apparatus according to claim 30, wherein the first information includes file management information and
the second information includes update information generated by updating the file management information.

32. A host apparatus according to claim 31, wherein the write-once recording medium includes at least one first track and at least one second track which is different from the at least one first track,
the at least one first track is an area for recording the file management information and
the at least one second track is an area for recording user data.

33. A host apparatus according to claim 31, wherein the first information further includes management information, the management information managing the file management information and
the second information includes first update information generated by updating the management information.

34. A drive apparatus included in a reproduction apparatus for reproducing second information from a write-once recording medium having first information and the second information recorded thereon, correlation information for correlating the first information and the second information being further recorded on the write-once recording medium, the reproduction apparatus further including a host apparatus for instructing the drive apparatus to reproduce the second information from the write-once recording medium, the drive apparatus comprising:
a head section for reproducing the second information from the write-once recording medium; and
a control section for controlling the head section to reproduce the second information from the write-once recording information based on the correlation information.

35. A drive apparatus according to claim 34, wherein the first information includes file management information,
the second information includes update information generated by updating the file management information,
first correlation information for correlating the file management information and the update information is recorded on the write-once recording medium and
the control section controls the head section to reproduce the update information from the write-once recording medium based on the first correlation information.

36. A drive apparatus according to claim 34, wherein the write-once recording medium includes at least one first track and at least one second track which is different from the at least one first track,
the at least one first track is an area for recording the file management information and
the at least one second track is an area for recording user data.

37. A drive apparatus according to claim 35, wherein the first information further includes management information, the management information managing the file management information,
the second information includes first update information generated by updating the management information,
second correlation information for correlating the management information and the first update information is recorded on the write-once recording medium and
the control section controls the head section to reproduce the first update information from the write-once recording medium based on the second correlation information.

38. A reproduction method for reproducing second information from a write-once recording medium having first information and the second information recorded thereon, correlation information for correlating the first information and the second information being further recorded on the write-once recording medium, the reproduction method comprising:
an instruction step of instructing to reproduce the second information from the write-once recording medium; and
a reproduction step of reproducing the second information from the write-once recording medium based on the correlation information.

39. An instruction method executed by a host apparatus included in a reproduction apparatus for reproducing second information from a write-once recording medium having first information and the second information recorded thereon, correlation information for correlating the first information and the second information being further recorded on the write-once recording medium, the reproduction apparatus reproducing the second information from the write-once recording medium based on the correlation information, the instruction method comprising:
an instruction step of instructing the drive apparatus to reproduce the second information from the write-once recording medium.

40. An method executed by a drive apparatus included in a reproduction apparatus for reproducing second information from a write-once recording medium having first information and the second information recorded thereon, correlation information for correlating the first information and the second information being further recorded on the write-once recording medium, the reproduction apparatus instructing the drive apparatus to reproduce the second information from the write-once recording medium, the method comprising:
a step of reproducing the second information from the write-once recording medium based on the correlation information.

41. A program for executing a reproduction procedure by a reproduction apparatus for reproducing second information from a write-once recording medium having first information and the second information recorded thereon, correlation information for correlating the first information and the second information being further recorded on the write-once recording medium, the reproduction procedure including
an instruction step of instructing to reproduce the second information from the write-once recording medium; and
a reproduction step for reproducing the second information from the write-once recording medium based on the correlation information.

42. A program for executing an instruction procedure by a host apparatus included in a reproduction apparatus for reproducing second information from a write-once recording medium having first information and the second information recorded thereon, correlation information for correlating the first information and the second information being further recorded on the write-once recording medium, the reproduction apparatus reproducing the second information from the write-once recording medium based on the correlation information, the instruction procedure including
an instruction step of instructing to record the second information on the write-once recording medium.

43. A program for executing a reproduction procedure by a drive apparatus included in a reproduction apparatus for reproducing second information from a write-once recording medium having first information and the second information recorded thereon, correlation information for correlating the first information and the second information being further recorded on the write-once recording medium, the reproduction apparatus instructing the drive apparatus to reproduce the second information from the write-once recording medium, the reproduction procedure including
a step of reproducing the second information from the write-once recording medium based on the correlation information.

44. An integrated circuit included in a reproduction apparatus for reproducing second information from a write-once recording medium having first information and the second information recorded thereon, wherein
correlation information for correlating the first information and the second information is further recorded on the write-once recording medium,
the reproduction apparatus further including a drive apparatus for reproducing the second information from the write-once recording medium based on the correlation information and
the integrated circuit instructs the drive apparatus to reproduce the second information from the write-once recording medium.

45. An integrated circuit included in a reproduction apparatus for reproducing second information from a write-once recording medium having first information and the second information recorded thereon, correlation information for correlating the first information and the second information being further recorded on the write-once recording medium, the reproduction apparatus further including an apparatus for instructing the integrated circuit to reproduce the second information from the write-once recording medium, the integrated circuit comprising:
a control section for reproducing the second information from the write-once recording medium based on the correlation information.

46. A write-once recording medium for recording first information, second information and correlation information for correlating the first information and the second information.
